(19) United States
(12) Patent Application Publication
(10) Pub. No.: US 2016/0364045 A1
(43) Pub. Date: Dec. 15, 2016

(54) SENSING DEVICE

(71) Applicant: IMAGE MATCH DESIGN INC., HSINCHU (TW)

(72) Inventors: YEN-KUO LO, TAINAN CITY (TW); CHIA-HUA YEH, HSINCHU CITY (TW)

(21) Appl. No.: 15/071,855

(22) Filed: Mar. 16, 2016

(30) Foreign Application Priority Data
Jun. 12, 2015 (TW) 104119039

(51) Int. Cl. G06F 3/044; G06F 3/01

(52) U.S. Cl. CPC G06F 3/044; G06F 3/016

(57) ABSTRACT

A sensing device includes a sensing component and a substrate. The sensing component is configured to extend in a first direction, and detect a capacitance in response to a touch event of an object on the sensing device. The substrate is configured to define a first capacitance with the sensing component, and provide a second capacitance. The first capacitance and the second capacitance are connected in series with respect to the sensing component.

### TECHNICAL FIELD

The present disclosure is generally related to an electronic device and, more particularly, to a sensing device.

### BACKGROUND

These days, touch devices are widely applied to electronic devices, for example, smart phones and laptop computers. With touch devices, users can easily operate on smart phones or laptop computers. However, sensitivity of some existing capacitive-type touch devices is not desirable due to stray capacitance. For example, the sensitivity of some existing touch devices does not present linearity, and may not be adjustable by a user. Moreover, source of trigger signal of such touch devices is predetermined and not an option selectable. Therefore, there is a need to provide a new touch device with a linear and enhanced sensitivity. Moreover, the sensitivity of the new touch device is adjustable by a user.

### SUMMARY

Embodiments of the present disclosure provide a sensing device. The sensing device includes a sensing component and a substrate. The sensing component is configured to extend in a first direction, and detect a capacitance in response to a touch event of an object. The substrate is configured to define a first capacitance with the sensing component, and provide a second capacitance. The first capacitance and the second capacitance are connected in series with respect to the sensing component.

In an embodiment, the sensing device further includes a signal source and an amplifier. The signal source is configured to supply a source trigger signal. The amplifier has an input coupled to the sensing component, and is configured to receive the source trigger signal.

In another embodiment, the sensing device further includes an amplifier and a first pair of conductive components. The amplifier has an input coupled to the sensing component, and is configured to receive a trigger signal from the outside of the sensing device. The first pair of conductive components is formed in patterned layers different from the sensing component, extends in the first direction, and defines a first feedback capacitance in a second direction. The first feedback capacitance is coupled between an input and an output of the amplifier.

In yet another embodiment, the sensing device further includes an amplifier, a signal source, a first pair of conductive components, a signal source switch and a first feedback switch. The amplifier has an input coupled to the sensing component, and is configured to receive a trigger signal. The signal source is configured to supply a source trigger signal. The first pair of conductive components is formed in patterned layers different from the sensing component, extends in the first direction, and defines a first feedback capacitance in a second direction. The first feedback capacitance is coupled between an input and an output of the amplifier. The signal source switch is coupled between the signal source and the input of the amplifier, and configured to be not conducted in response to an event that the trigger signal is from the outside of the sensing device while to be conducted in response to an event that the trigger signal is the source trigger signal provided by the signal source. The first feedback switch is configured to be connected in series with the first feedback capacitance between the output and the input of the amplifier, and configured to be conducted, in response to an event that the trigger signal is from the outside of the sensing device, to be conducted while to be not conducted, in response to an event that the trigger signal is the source trigger signal provided by the signal source.

In still another embodiment, the first pair of conductive components has a first size in the first direction. The sensing device further includes a second pair of conductive components. The second pair of conductive components is configured to extend in the first direction, have a second size in the first direction, and define a second feedback capacitance in the second direction. The second feedback capacitance and the first feedback capacitance are connected in parallel between the input and the output of the amplifier.

In yet still another embodiment, the sensing device further includes a first feedback switch and a second feedback switch. The first feedback switch is configured to be connected in series with the first feedback capacitance between the output and the input of the amplifier, and configured to be selectively conducted. The second feedback switch is configured to be connected in series with the second feedback capacitance between the output and the input of the amplifier, and configured to be selectively conducted. At least one of the first feedback switch and the second feedback switch is conducted.

In a further embodiment, the sensing device further includes an amplifier, a signal source, a first pair of conductive components, a second pair of conductive components, a signal source switch, a first feedback switch and a second feedback switch. The amplifier has an input coupled to the sensing component, and is configured to receive a trigger signal. The signal source is configured to supply a source trigger signal. The first pair of conductive components is formed in patterned layers different from the sensing component, extend in the first direction, have a first size in the first direction, and define a first feedback capacitance in a second direction. The first feedback capacitance is coupled between the input and an output of the amplifier. The second pair of conductive components is configured to extend in the first direction, have a second size in the first direction, and define a second feedback capacitance in the second direction. The second feedback capacitance and the first feedback capacitance are connected in parallel between the input and the output of the amplifier. The signal source switch is coupled between the signal source and the input of the amplifier, and configured to be not conducted in response to an event that the trigger signal is from the outside of the sensing device while to be conducted in response to an event that the trigger signal is the source trigger signal provided by the signal source. The first feedback switch is configured to be connected in series with the first feedback capacitance between the output and the input of the amplifier, and configured to be not conducted in response to an event that the trigger signal is the source trigger signal provided by the signal source. The second feedback switch is configured to be connected in series with the second feedback capacitance between the output and the input of the amplifier, and configured to be not conducted in response to an event that the trigger signal is the source trigger signal provided by the signal source. At least one of the first feedback switch and the second feedback switch is conducted in response to an event that the trigger signal is from the outside of the sensing device.

In further another embodiment, the first pair of conductive components includes a first conductive component and a second conductive component, which are spaced apart by a first distance in the second direction. The sensing device further includes a third pair of conductive components. The third pair of conductive components is configured to extend in the first direction, and define a third feedback capacitance in the second direction. The third feedback capacitance is connected with the first feedback capacitance in parallel between the input and the output of the amplifier. The third pair of conductive components includes a first conductive component and a second conductive component, which are spaced apart by a second distance different from the first distance in the second direction.

In still further another embodiment, the sensing device further includes a first feedback switch and a third feedback switch. The first feedback switch is configured to be connected in series with the first feedback capacitance between the output and the input of the amplifier, and configured to be selectively conducted. The third feedback switch is configured to be connected in series with the third feedback capacitance between the output and the input of the amplifier, and configured to be selectively conducted. At least one of the first feedback switch and the third feedback switch is conducted.

In yet still further another embodiment, the sensing device further includes an amplifier, a signal source, a first pair of conductive components, a third pair of conductive components, a signal source switch, a first feedback switch and a third feedback switch. The amplifier has an input coupled to the sensing component, and is configured to receive a trigger signal. The signal source is configured to supply a source trigger signal. The first pair of conductive components is arranged in patterned layers different from the sensing component, extend in the first direction, and define a first feedback capacitance in a second direction. The first feedback capacitance is coupled between the input and an output of the amplifier. The first pair of conductive components includes a first conductive component and a second conductive component, which are spaced apart by a first distance in the second direction. The third pair of conductive components is configured to extend in the first direction, and define a third feedback capacitance in the second direction. The third feedback capacitance is connected with the first feedback capacitance in parallel between the input and the output of the amplifier. The third pair of conductive components includes a first conductive component and a second conductive component, which are spaced apart by a second distance different from the first distance in the second direction. The signal source switch is coupled between the signal source and the input of the amplifier, and is configured to be not conducted in response to an event that the trigger signal is from the outside of the sensing device while to be conducted in response to an event that the trigger signal is the source trigger signal provided by the signal source. The first feedback switch is configured to be connected in series with the first feedback capacitance between the output and the input of the amplifier, and configured to be not conducted in response to an event that the trigger signal is the source trigger signal provided by the signal source. The third feedback switch is configured to be connected in series with the third feedback capacitance between the output and the input of the amplifier, and configured to be not conducted in response to an event that the trigger signal is the source trigger signal provided by the signal source. When the signal source switch is not conducted, at least one of the first feedback switch and the third feedback switch is conducted.

In a yet further embodiment, the first pair of conductive components includes a first conductive component and a second conductive component, which are spaced apart by a first distance in the second direction. The sensing device further includes a third pair of conductive components. The third pair of conductive components is configured to extend in the first direction and define a third feedback capacitance in the second direction. The third feedback capacitance is connected with the first feedback capacitance in parallel between the input and the output of the amplifier. The third pair of conductive components includes a first conductive component and a second conductive component, which are spaced apart by a second distance different from the first distance in the second direction.

In a still yet embodiment, the sensing device further includes a first feedback switch, a second feedback switch and a third feedback switch. The first feedback switch is configured to be connected in series with the first feedback capacitance between the output and the input of the amplifier, and configured to be selectively conducted. The second feedback switch is configured to be connected in series with the second feedback capacitance between the output and the input of the amplifier, and configured to be selectively conducted. The third feedback switch is configured to be connected in series with the third feedback capacitance between the output and the input of the amplifier, and configured to be selectively conducted. At least one of the first feedback switch, the second feedback switch and the third feedback switch is conducted.

In a further yet embodiment, the first pair of conductive components includes a first conductive component and a second conductive component, which are spaced apart by a first distance in the second direction. The sensing device further includes a third pair of conductive components and a third feedback switch. The third pair of conductive components is configured to extend in the first direction and defining a third feedback capacitance in the second direction. The third feedback capacitance connected with the first feedback capacitance in parallel between the input and the output of the amplifier. The third pair of conductive components includes a first conductive component and a second conductive component, which are spaced apart by a second distance different from the first distance in the second direction. The third feedback switch is configured to be connected in series with the third feedback capacitance between the output and the input of the amplifier, and configured to be not conducted in response to an event that the trigger signal is the source trigger signal provided by the signal source. When the signal source switch is not conducted, at least one of the first feedback switch, the second feedback switch and the third feedback switch is conducted.

In a still further yet embodiment, a sensing device includes a sensing component, a substrate and an amplifier. The sensing component is configured to detect a capacitance in response to a touch event of an object on the sensing device. The substrate is configured to define a first capacitance with the sensing component, and provide a second capacitance. The amplifier has an output. A voltage level at the output of the amplifier is a function of the first capacitance and the second capacitance.

In a still yet further embodiment, the amplifier receives a trigger signal at an input of the amplifier. The voltage level at the output of the amplifier and the first and second capacitance have a relationship below.

$$\frac{Vout}{Vin 1} = - [ \frac{{C}_{in}}{{C}_{in} + {C}_{F} + ( \frac{{C}_{PF} \times {C}_{JUN}}{{C}_{PF} \times {C}_{JUN}} )} ] \times G$$

where Vin1 represents a voltage level of the trigger signal, wherein the trigger signal is provided by a signal source of the sensing device, Vout represents the voltage level at the output of the amplifier, Cᵢₙ represents a capacitance of a capacitor, wherein the trigger signal is input to the input of the amplifier via the capacitor, G represents an open-loop gain of the amplifier, C_{F} represents the capacitance, C_{PF} represents the first capacitance, and C_{JUN} represents the second capacitance.

In an additional embodiment, the sensing device further includes a first pair of conductive components. The first pair of conductive components defines a first feedback capacitance. The voltage level at the output of the amplifier is a function of the first feedback capacitance.

In a further embodiment again, the amplifier receives a trigger signal at an input of the amplifier. The voltage level at the output of the amplifier and the first feedback capacitance have a relationship below.

$$\frac{Vout}{Vin 2} = - [ \frac{{C}_{in}}{( \frac{G + 1}{G} ) \times {C}_{1} + \frac{{C}_{F}}{G} + \frac{( \frac{{C}_{PF} \times {C}_{JUN}}{{C}_{PF} \times {C}_{JUN}} )}{G}} ]$$

where Vin2 represents a voltage level of the trigger signal, wherein the trigger signal is input from the outside of the sensing device, Vout represents the voltage level at the output of the amplifier, G represents an open-loop gain of the amplifier, C_{F} represents the capacitance, C_{PF} represents the first capacitance, C_{JUN} represents the second capacitance, and C₁ represents the first feedback capacitance.

In an embodiment, the first pair of conductive components has a first size in a first direction. The first size is a factor of the first feedback capacitance. The sensing device further includes a second pair of conductive components. The second pair of conductive components has a second size in the first direction, and defines a second feedback capacitance. The second size is a factor of the second feedback capacitance. An equivalent capacitance between an input and the output of the amplifier is a sum of the first feedback capacitance and the second feedback capacitance. The voltage level at the output of the amplifier is a function of the equivalent capacitance.

In an embodiment, the amplifier receives a trigger signal at the input of the amplifier. The voltage level at the output of the amplifier and the equivalent capacitance have a relationship below.

$$\frac{Vout}{Vin 2} = - [ \frac{{C}_{in}}{( \frac{G + 1}{G} ) \times ( {C}_{1} + {C}_{2} ) + \frac{{C}_{F}}{G} + \frac{( \frac{{C}_{PF} \times {C}_{JUN}}{{C}_{PF} + {C}_{JUN}} )}{G}} ]$$

where Vin2 represents a voltage level of the trigger signal, wherein the trigger signal is input from the outside of the sensing device, Vout represents the voltage level at the output of the amplifier, G represents an open-loop gain of the amplifier, C_{F} represents the capacitance, C_{PF} represents the first capacitance, C_{JUN} represents the second capacitance, C₁ represents the first feedback capacitance, and C₂ represents the second feedback capacitance.

In an embodiment, the first pair of conductive components includes a first conductive component and a second conductive component, which are spaced apart by a first distance in a second direction. The first distance is a factor of the first feedback capacitance.

The sensing device further includes a third pair of conductive components. The third pair of conductive components is configured to define a third feedback capacitance. The third pair of conductive components includes a first conductive component and a second conductive component, which are spaced apart by a second distance different from the first distance in the second direction. The second distance is a factor of the third feedback capacitance. An equivalent capacitance between an input and the output of the amplifier is a sum of the first feedback capacitance and the third feedback capacitance. The voltage level at the output of the amplifier is a function of the equivalent capacitance.

In an embodiment, the first pair of conductive components includes a first conductive component and a second conductive component, which are spaced apart by a first distance in a second direction. The first distance is a factor of the first feedback capacitance. The sensing device further includes a third pair of conductive components. The third pair of conductive components is configured to define a third feedback capacitance. The third pair of conductive components includes a first conductive component and a second conductive component, which are spaced apart by a second distance different from the first distance in the second direction. The second distance is a factor of the third feedback capacitance. An equivalent capacitance between the input and the output of the amplifier is a sum of the first feedback capacitance, the second feedback capacitance and the third feedback capacitance. The voltage level at the output of the amplifier is a function of the equivalent capacitance.

In an embodiment, the amplifier receives a trigger signal at the input of the amplifier. The voltage level at the output of the amplifier and the equivalent capacitance has a relationship below.

$$\frac{Vout}{Vin 2} = - [ \frac{{C}_{in}}{( \frac{G + 1}{G} ) \times ( {C}_{1} + {C}_{2} + {C}_{3} ) + \frac{{C}_{F}}{G} + \frac{( \frac{{C}_{PF} \times {C}_{JUN}}{{C}_{PF} + {C}_{JUN}} )}{G}} ]$$

where Vin2 represents a voltage level of the trigger signal, wherein the trigger signal is input from the outside of the sensing device, Vout represents the voltage level at the output of the amplifier, G represents an open-loop gain of the amplifier, C_{F} represents the capacitance, C_{PF} represents the first capacitance, C_{JUN} represents the second capacitance, C₁ represents the first feedback capacitance, C₂ represents the second feedback capacitance, and C₃ represents the third feedback capacitance.

In an embodiment, with the feedback switch, the touch sensitivity of the sensing device is selectable for a user.

Moreover, in an embodiment, with the second capacitance being connected with the first capacitance in series with respect to the second input of the amplifier, the touch sensitivity of the sensing device becomes batter.

Furthermore, in an embodiment, with a feedback switch and a signal source switch, a source of a trigger signal is selectable for a user, and therefore the sensing device has relatively wide versatility.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

Details of one or more embodiments of the disclosure are set forth in the accompanying drawings and the description below. Other features and advantages of the disclosure will be apparent from the description, drawings and claims.

FIG. 1 is a top view of a sensing device, in accordance with an embodiment of the present disclosure.

FIG. 2A is a schematic diagram of exemplary sensing units in the sensing device shown in FIG. 1, in accordance with an embodiment of the present disclosure.

FIG. 2B is a circuit diagram of an amplifier circuit, in a small-signal mode, of the sensing device shown in FIG. 2A.

FIG. 3A is a schematic diagram of a sensing unit in a sensing device, in accordance with an embodiment of the present disclosure.

FIG. 3B is a circuit diagram of an amplifier circuit, in a small-signal mode, of the sensing device shown in FIG. 3A.

FIG. 4 is a schematic diagram of a sensing unit in a sensing device, in accordance with an embodiment of the present disclosure.

FIG. 5A is a schematic diagram of a sensing unit in a sensing device, in accordance with an embodiment of the present disclosure.

FIG. 5B is a circuit diagram of an amplifier circuit, in a small-signal mode, of the sensing device shown in FIG. 5A.

FIG. 6A is a schematic diagram of a sensing unit in a sensing device, in accordance with an embodiment of the present disclosure.

FIG. 6B is a circuit diagram of an amplifier circuit, in a small-signal mode, of the sensing device shown in FIG. 6A.

FIG. 7 is a schematic diagram of a sensing unit in a sensing device, in accordance with an embodiment of the present disclosure.

FIG. 8 is a schematic diagram of a sensing unit in a sensing device, in accordance with an embodiment of the present disclosure.

FIG. 9 is a schematic diagram of a sensing unit in a sensing device, in accordance with an embodiment of the present disclosure.

FIG. 10 is a schematic diagram of a sensing unit in a sensing device, in accordance with an embodiment of the present disclosure.

FIG. 11A is a schematic diagram of a sensing unit in a sensing device, in accordance with an embodiment of the present disclosure.

FIG. 11B is a circuit diagram of an amplifier circuit, in a small-signal mode, of the sensing device shown in FIG. 11A.

FIG. 12 is a schematic diagram of a sensing unit in a sensing device, in accordance with an embodiment of the present disclosure.

FIG. 13 is a schematic diagram of a sensing unit in a sensing device, in accordance with an embodiment of the present disclosure.

### DETAIL DESCRIPTION

In order to make the disclosure completely comprehensible, detailed steps and structures are provided in the following description. Obviously, implementation of the disclosure does not limit special details known by persons skilled in the art. In addition, known structures and steps are not described in detail, so as not to limit the disclosure unnecessarily. Preferred embodiments of the disclosure will be described below in detail. However, in addition to the detailed description, the disclosure may also be widely implemented in other embodiments. The scope of the disclosure is not limited to the detailed description, and is defined by the claims.

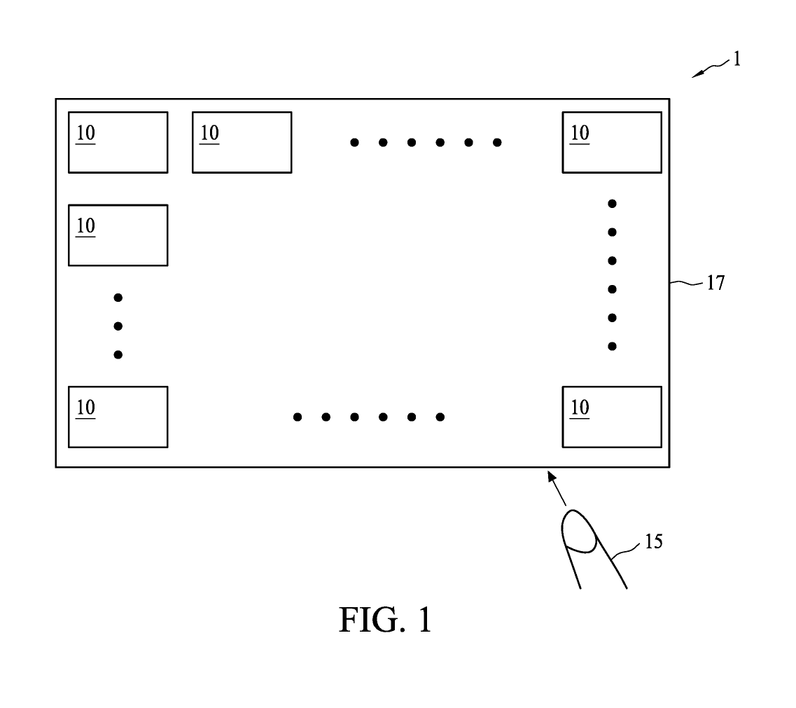

FIG. 1 is a top view of a sensing device 1, in accordance with an embodiment of the present disclosure. The sensing device 1 is adapted to be installed in an electronic device, such as a smart phone, a laptop computer, a personal digital assistant, or a tablet. The sensing device 1 includes an array of sensing units 10, covered by a passivation layer 17. The sensing units 10 are configured to sense a touch event of an object 15, such as a finger or a touch pen, when touching the sensing device 1 via the passivation layer 17.

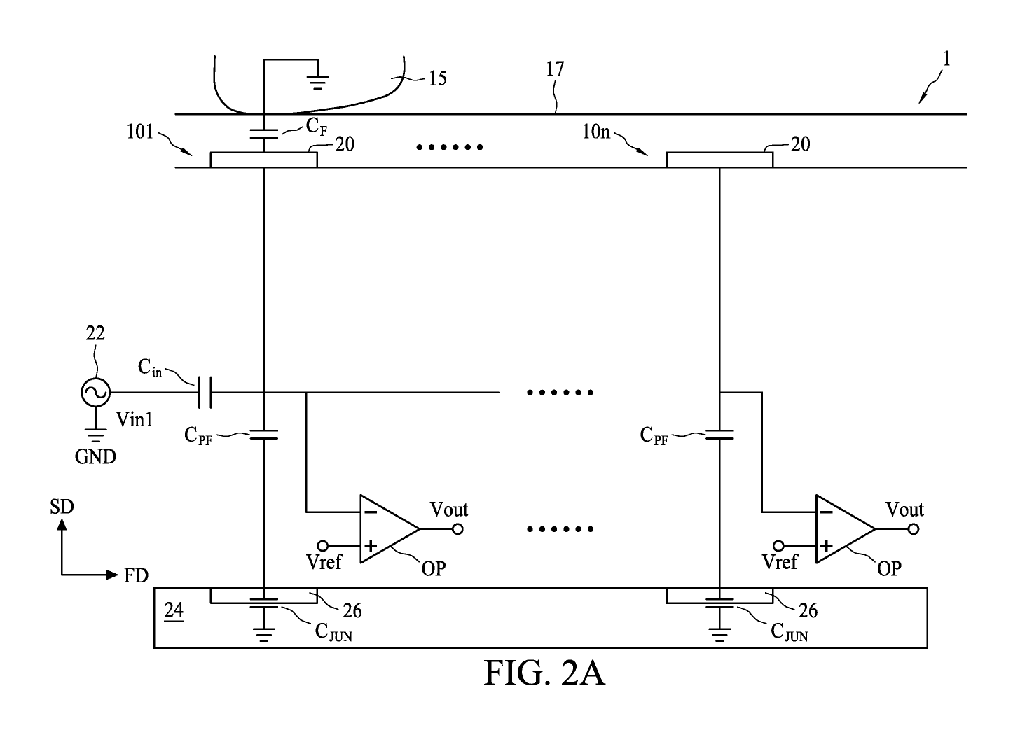

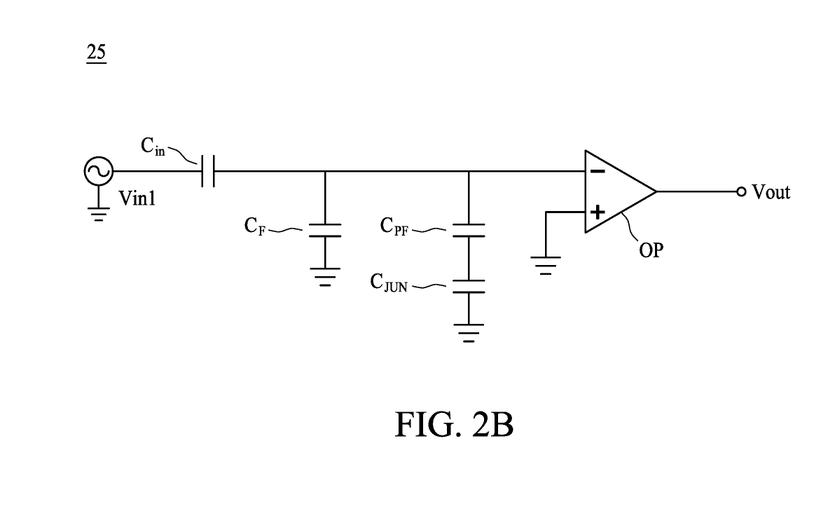

FIG. 2A is a diagram of a sensing device 1, in accordance with an embodiment of the present disclosure. Referring to FIG. 2A, the sensing device 1 includes a signal source 22, a capacitor Cᵢₙ, a substrate 24 and a plurality of sensing units 101-10n, n being a natural number. For convenience, only exemplary sensing units 101 and 10n are shown.

The signal source 22 is coupled to a reference ground GND, and is configured to provide a source trigger signal Vin1. In some embodiments, the source trigger signal Vin1 includes a pulse signal.

The capacitor Cᵢₙ is configured to isolate a direct-current component input via the signal source 22.

The substrate 24 includes a plurality of doped regions 26. Each of the doped regions 26 corresponds to one of the sensing units 101-10n. A voltage level of the substrate 24 can be deemed as a reference ground GND, and the doped regions 26 are free from being biased. In the present embodiment, the substrate 24 is a P-type substrate, and the doped regions 26 are N-type well regions. In some embodiments, the substrate 24 is an N-type substrate, and the doped regions 26 are P-type well regions. As a result, the substrate 24 and the doped region 26 form a depletion region at the junction therebetween. The substrate 24 thus provides a capacitance C_{JUN}, which is a depletion capacitance.

In some existing approaches, there is no motivation to arrange a well region such as the doped region 26 below a sensing component such as a sensing component 20 for the reason that if the well region is arranged below the sensing component, leakage current may occur. In contrast, in the present disclosure, the well region is arranged below the sensing component, and the touch sensitivity of the sensing device is thereby enhanced, which will be described in detail below. In the sensing device 1 according to the present disclosure, no significant leakage current is likely to occur. Even though leakage current takes place, the magnitude of the leakage current is considerably small and therefore may be ignored.

The sensing units 101 to 101n have substantially the same components, arrangement and operations. In the present embodiment, the sensing units 101 to 10n share the substrate 24. In some embodiments, the sensing units 101 to 10n share the signal source 22. Taking the sensing unit 101 for instance, in operation, the sensing unit 101 is configured to detect a touch event of the object 15. Moreover, the sensing unit 101 includes a sensing component 20, an amplifier OP and a doped region 26.

The sensing component 20 is formed in a first patterned conductive layer, and extends in a first direction FD. Moreover, the sensing component 20 faces towards the object 15 for sensing a touch event of the object 15 when touching the sensing device 1 (or touching the passivation layer 17). Furthermore, the sensing component 20 is arranged to define a first capacitance C_{PF} with the doped region 26.

For convenience, a same reference numeral or label is used to refer to a capacitor or, when appropriate, its capacitance throughout the disclosure, and vice versa. For example, while the reference label “C_{PF}” as above mentioned refers to a capacitance, it may represent a capacitor having the capacitance.

The first capacitor C_{PF} is connected with the capacitor C_{JUN} (hereinafter the second capacitor) in series with respect to the sensing component 20. In some embodiments, the sensing component 20 is arranged over the doped region 26. In some embodiments, a portion of the sensing component 20 is arranged over the doped region 20. The sensing component 20 includes a material selected from, but is not limited to, poly or metal.

The amplifier OP in a semiconductor manufacturing process is formed on and/or in the substrate 24. For convenience of illustration, the amplifier OP is shown as a circuit symbol in FIG. 2A. The amplifier OP has a first input (a non-inverting terminal, “+” terminal), a second input (an inverting terminal, “−”terminal) and an output. The first input is configured to receive a reference voltage Vref. The second input is coupled to the sensing component 20 and the doped region 26. Moreover, the second input is configured to receive the source trigger signal Vin1.

In operation, the sensing device 1 detects a capacitance C_{F} in response to a touch event of the object 15 on the sensing device 1. Specifically, the sensing component 20 detects a capacitance C_{F} in response to a touch event of the object 15 on the sensing device 1. During the touch event, the object 15, the substrate 24, the signal source 22 and the sensing unit 101 constitute an amplifier circuit shown in FIG. 2B.

FIG. 2B is a circuit diagram of an amplifier circuit 25, in a small-signal mode, of the sensing device 1 shown in FIG. 2A. Referring to FIG. 2B, in the small-signal operation, the reference voltage Vref can be deemed as the reference ground GND, and a voltage level of the object 15 may also be regarded as the reference ground GND. Therefore, the first input of the amplifier OP is coupled to the reference ground GND, and the capacitor C_{F} is coupled to the reference ground GND. The first capacitor C_{PF} is connected with the second capacitor C_{JUN} in series between the second input of the amplifier OP and the reference ground GND. The capacitor C_{F} is coupled between the second input of the amplifier OP and the reference ground GND.

The amplifier OP receives the source trigger signal Vin1 at its second input, amplifies the source trigger signal Vin1 and outputs a detection signal Vout at its output. The detection signal Vout is the source trigger signal Vin1 amplified. The detection signal Vout and the source trigger signal Vin1 have a relationship in equation (1) below.

$$\frac{Vout}{Vin 1} = - [ \frac{{C}_{in}}{{C}_{in} + {C}_{F} + ( \frac{{C}_{PF} \times {C}_{JUN}}{{C}_{PF} \times {C}_{JUN}} )} ] \times G \qquad equation ( 1 )$$

where G represents an open-loop gain of the amplifier OP, and Cᵢₙ, C_{F}, C_{PF} and C_{JUN} are the capacitances of their respective capacitors. Moreover, the term (C_{PF}×C_{JUN}/C_{PF}+C_{JUN}) represents an equivalent capacitance of the serially connected first capacitance C_{PF} and second capacitance C_{JUN}. Furthermore, in equation (1), Vout also represents a voltage level of the detection signal Vout, and Vin1 also represents a voltage level of the trigger source signal Vin1. The voltage level of the detection signal Vout is substantially equal to that at the output of the amplifier OP.

The absolute value of a ratio of the detection signal Vout to the source trigger signal Vin1 represents the gain of the amplifier circuit 25. From equation (1), the gain of the amplifier circuit 25 is a function of the equivalent capacitance (i.e., (C_{PF}×C_{JUN}/C_{PF}+C_{JUN})). The gain of the amplifier circuit 25 decreases as the equivalent capacitance increases, and vice versa.

Moreover, the voltage level at the output of the amplifier OP is a function of the second capacitance C_{JUN}. For example, the voltage level at the output of the amplifier OP increases as the second capacitance C_{JUN} decreases. Also, the voltage level at the output of the amplifier OP is a function of the first capacitor C_{PF}. In addition, the voltage level at the output of the amplifier OP is a function of the first capacitance C_{PF} and the second capacitance C_{JUN}.

In some existing approaches, the substrate is free of any doped region like the doped region 26. Other things being equal, in the existing approaches the sensing component 20 and the substrate define a capacitance C_{X} therebetween. Consequently, a detection signal Vout and a source trigger signal Vin1 have a relationship in equation (2) below.

$$\frac{Vout}{Vin 1} = - [ \frac{{C}_{in}}{{C}_{in} + {C}_{F} + {C}_{X}} ] \times G \qquad equation ( 2 )$$

By comparing equations (1) with (2), the difference lies in the term (C_{PF}×C_{JUN}/C_{PF}+C_{JUN}) in equation (1) and the term (C_{X}) in equation (2). The first capacitance C_{PF} defined by the sensing component 20 and the doped region 26 in the present embodiments is substantially the same as the capacitance C_{X} defined by the sensing component 20 and the substrate in the existing approaches. As a result, the value of the term (C_{PF}×C_{JUN}/C_{PF}+C_{JUN}) is smaller than that of the term (C_{X}). It can be realized that the absolute value of the ratio of the detection signal Vout to the source trigger signal Vin1 in equation (1) is greater than that in equation (2). The absolute value of the ratio is positively correlated to the touch sensitivity. Therefore, the touch sensitivity of the sensing device 1 is better than that in the existing approaches.

In the embodiment of FIG. 2B, the gain of the amplifier circuit 25 is enhanced by introducing the second capacitor C_{JUN} in serial connection with the first capacitor C_{PF} with respect to the second input of the amplifier OP. Accordingly, the touch sensitivity of the sensing device 1 is enhanced.

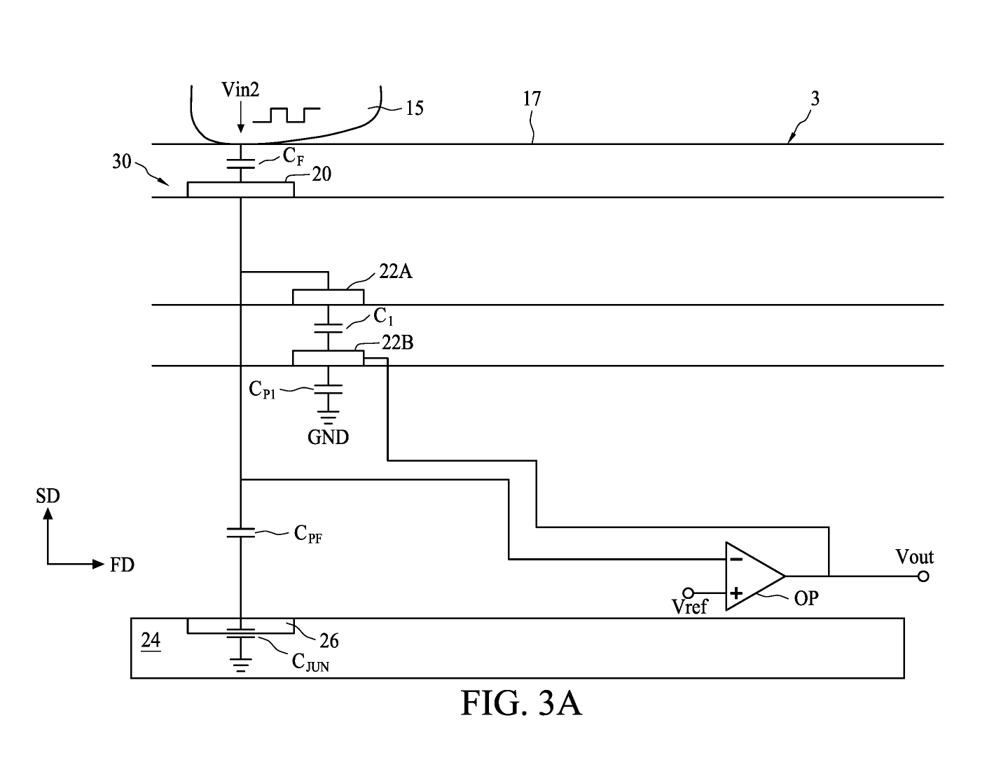

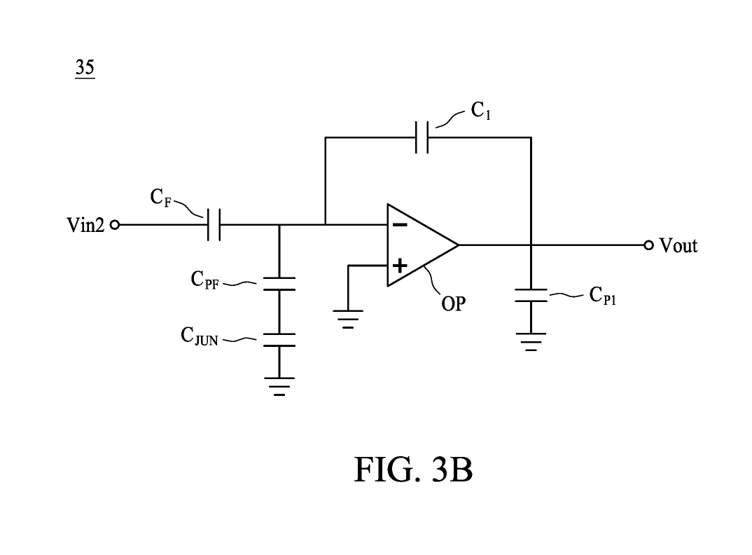

FIG. 3A is a schematic diagram of a sensing unit 30 in a sensing device 3, in accordance with an embodiment of the present disclosure. Referring to FIG. 3A, the sensing device 3 is similar to the sensing device 1 described and illustrated with reference to FIG. 2A except, for example, sensing units 30 of the sensing device 3. For convenience of illustration, only an exemplary sensing unit 30 is shown in FIG. 3A. The sensing unit 30 is similar to the sensing unit 101 described and illustrated with reference to FIG. 2A except that, for example, the sensing unit 30 includes a first pair of conductive components 22A and 22B. The first pair of conductive components 22A and 22B are arranged (or formed) in patterned conductive layers different from the first patterned conductive layer associated with the sensing component 20, which will be described in detail below. The first pair of conductive components 22A and 22B, extending in the first direction FD, define a first feedback capacitance C₁.

The conductive component 22A is arranged in a second patterned conductive layer, and extends in the first direction FD. The conductive component 22A is coupled to the sensing component 20 and the substrate 24. The conductive component 22A includes a material selected from, but is not limited to, poly or metal.

The conductive component 22B is arranged in a third patterned conductive layer, and extends in the first direction FD. The conductive components 22A and 22B are separated in a second direction SD by, for example, dielectric materials. In some embodiments, the first direction FD is orthogonal to the second direction SD. The conductive component 22B is coupled to an output of the amplifier OP. Moreover, the conductive component 22B and the substrate 24 define a capacitance C_{P1} therebetween. To clarify illustration, the capacitance C_{P1} is depicted between the second component 22B and the reference ground GND.

In operation, the sensing device 3, or specifically the sensing component 20, detects a capacitance C_{F} in response to a touch event of the object 15 on the sensing device 3. During the touch event, a trigger signal Vin2 is input from the outside of the sensing device 3 in response to the touch event, and coupled via the capacitor C_{F} to the second input of the amplifier OP. In some embodiments, the trigger signal Vin2 is provided by a device external to the sensing device 3. In some embodiments, the trigger signal Vin2 is generated by the sensing device 3, transmitted to a metal frame (not shown) on the sensing device 3 (i.e., outside the sensing device 3), and then transmitted back via the object 15 to the sensing device 3 when the object 15 touches the metal frame on the sensing device 3. Moreover, during the touch event, the object 15, the substrate 24 and the sensing unit 30 constitute an amplifier circuit shown in FIG. 3B.

FIG. 3B is a circuit diagram of an amplifier circuit 35, in a small-signal mode, of the sensing device 3 shown in FIG. 3A. Referring to FIG. 3B, the first capacitor C_{PF} and the second capacitor C_{JUN} are connected in series between the second input of the amplifier OP and the reference ground GND. The first feedback capacitor C₁ establishes a first feedback path between the second input and the output of the amplifier OP.

The amplifier OP receives the trigger signal Vin2 at its second input, amplifies the trigger signal Vin2, and generates the detection signal Vout at its output. The detection signal Vout and the trigger signal Vin2 have a relationship in equation (3) below.

$$\frac{Vout}{Vin 2} = - [ \frac{{C}_{in}}{( \frac{G + 1}{G} ) \times {C}_{1} + \frac{{C}_{F}}{G} + \frac{( \frac{{C}_{PF} \times {C}_{JUN}}{{C}_{PF} \times {C}_{JUN}} )}{G}} ] \qquad equation ( 3 )$$

Similar to those described and illustrated with reference to FIG. 2B, a voltage level at the output of the amplifier OP is a function of the first feedback capacitance C₁.

Similar to those described and illustrated with reference to FIG. 2B, in the embodiment of FIG. 3B, the gain of the amplifier circuit 35 is enhanced by introducing the second capacitor C_{JUN} in serial connection with the first capacitor C_{PF} with respect to the second input of the amplifier OP. The touch sensitivity of the sensing device 3 is thus enhanced.

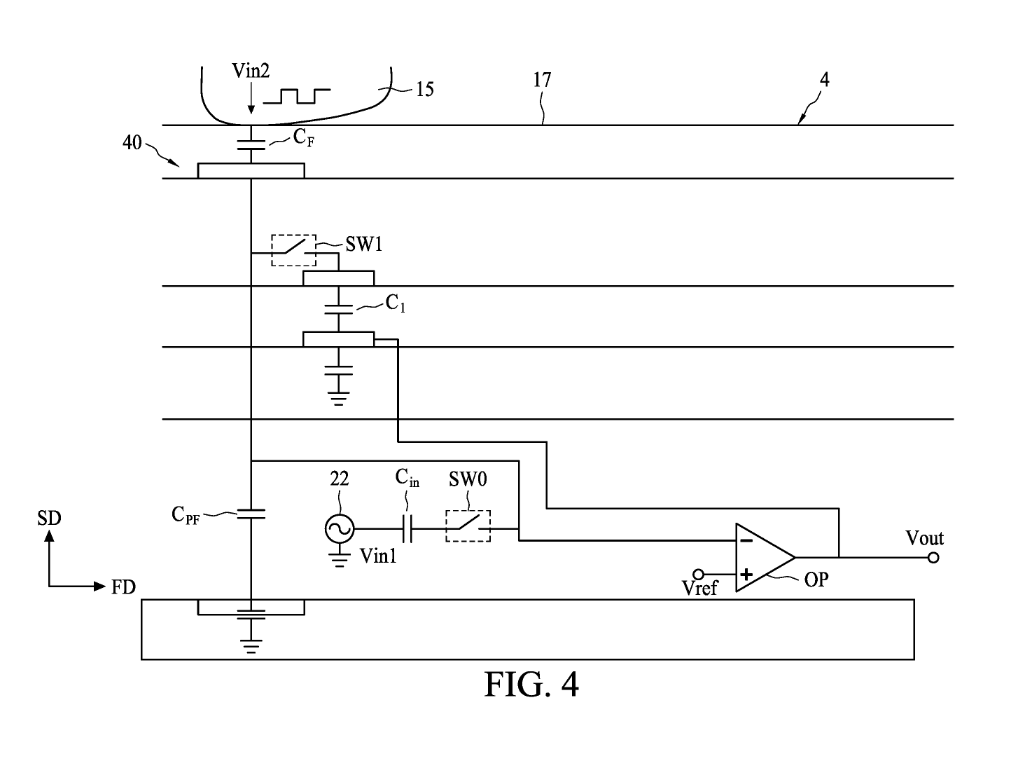

FIG. 4 is a schematic diagram of a sensing unit 40 in a sensing device 4, in accordance with an embodiment of the present disclosure.

Referring to FIG. 4, the sensing device 4, substantially similar to the sensing device 3 described and illustrated with reference to FIG. 3A, includes a sensing unit 40, a signal source 22, a capacitor C₁ and a signal source switch SW0. The sensing unit 40 is similar to the sensing unit 30 described and illustrated with reference to FIG. 3A except that, for example, the sensing unit 40 further includes a first feedback switch SW1. Functions of the signal source switch SW0 and the first feedback switch SW1 are described below.

The signal source switch SW0, coupled between the signal source 22 and the second input of the amplifier OP, is not conducted in response to an event that a trigger signal (such as a trigger signal Vin2) is input from the outside of the sensing device 4, and is conducted in response to an event that a trigger signal is a source trigger signal Vin1 provided by the signal source 22.

In the present embodiment, a user can select a source of a trigger signal, such that the trigger signal is either provided by the signal source 22, or input from the outside of the sensing device 4. For example, in an operation mode, the user selects the trigger signal provided by the signal source 22. In that case, the signal source switch SW0 is conducted in response to an event that the trigger signal is the source trigger signal Vin1 provided by the source signal 22. Moreover, the first feedback switch SW1 is not conducted in response to an event that the trigger signal is the source trigger signal Vin1 provided by the source signal 22. In this situation, no trigger signal Vin2 is input to the second input of the amplifier OP. Additionally, the source trigger signal Vin1 is coupled to the second input of the amplifier OP via the capacitor C. Furthermore, since the trigger signal is provided by the source signal 22, the object 15 is deemed as a reference ground GND. In operation, the sensing component 20 detects a capacitance C_{F} in response to a touch event of the object 15 on the sensing device 4. During the touch event, in such operation mode, an amplifier circuit, in a small-signal mode, of the sensing device 4 is substantially the same as the amplifier circuit 25 shown in FIG. 2B.

In another operation, the user selects the trigger signal input from the outside of the sensing device 4. That is, the user selects the trigger signal Vin2. In that case, the signal source switch SW0 is not conducted in response to an event that a trigger signal is input from the outside of the sensing device 4. Moreover, the first feedback switch SW1 is conducted in response to an event that a trigger signal is input from the outside of the sensing device 4. In this situation, the source trigger signal Vin1 is not input to the second input of the amplifier OP, while the trigger signal Vin2 is input to the second input of the amplifier OP. In operation, the sensing component 20 detects the capacitance C_{F} in response to a touch event of the object 15 on the sensing device 4. During the touch event, in such operation mode, an amplifier circuit, in a small-signal mode, of the sensing device 4 is substantially the same as the amplifier circuit 35 shown in FIG. 3B.

In the present embodiment, by introducing the first feedback switch SW1 and the source signal switch SW0, the user can select a source of a trigger signal. Therefore, the sensing device 4 provides a relatively flexible selection of signal source.

Moreover, similar to those described and illustrated with reference to FIG. 2B, in the embodiment of FIG. 4, by introducing the second capacitor C_{JUN} in serial connection with the first capacitor C_{PF} with respect to the second input of the amplifier OP, the touch sensitivity of the sensing device 4 is enhanced.

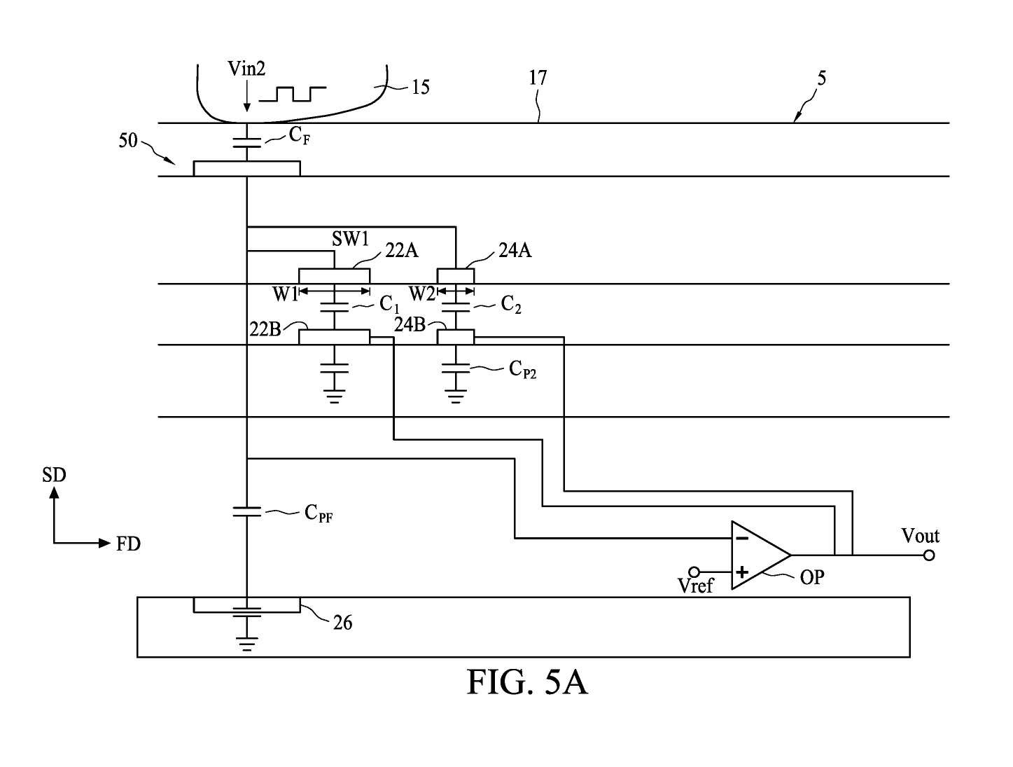

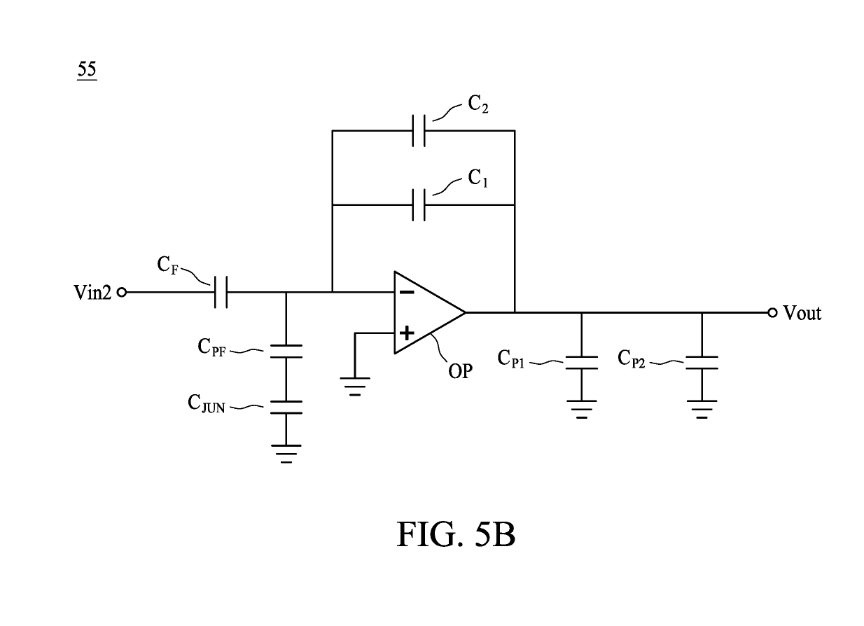

FIG. 5A is a schematic diagram of a sensing unit 50 in a sensing device 5, in accordance with an embodiment of the present disclosure. Referring to FIG. 5A, the sensing device 5 is similar to the sensing device 3 described and illustrated with reference to FIG. 3A except, for example, sensing units 50 of the sensing device 5. The sensing unit 50 is similar to the sensing unit 30 described and illustrated with reference to FIG. 3A except that, for example, the sensing unit 50 further includes a second pair of conductive components 24A and 24B. The second pair of conductive components 24A and 24B defines a second feedback capacitance C₂.

The conductive component 24A is arranged (formed) in the second patterned conductive layer, and extends in the first direction FD. The conductive component 24A is coupled to the sensing component 20 and the substrate 24. The conductive component 24A includes a material selected from, but is not limited to, poly or metal. In some embodiments, the conductive component 24A is arranged in a patterned conductive layer other than the first patterned conductive layer where the sensing component 20 is formed.

The conductive component 24B is arranged in the third patterned conductive layer, and extends in the first direction FD. The conductive components 24A and 24B are separated from each other in the second direction SD by, for example, dielectric materials. The conductive component 24B is coupled to the output of the amplifier OP. Moreover, the conductive component 24B and the substrate 24 define a capacitance C_{P2}. The conductive component 24B includes a material selected from, but is not limited to, poly or metal.

In some embodiments, the conductive components 24A and 22A are arranged in different patterned conductive layers. Also, the conductive components 24B and 22B are arranged in different patterned conductive layers.

The first pair of conductive components 22A and 22B has a first size W1 in the first direction FD. The second pair of conductive components 24A and 24B has a second size W2 in the first direction FD. In some embodiments, the first size W1 is the same as the second size W2. In some embodiments, the first size W1 is smaller than the second size W2. In some embodiments, the first size W1 is larger than the second size W2.

In the present embodiment, the first size W1 is a factor of, and positively correlated to, the first feedback capacitance C₁. The second size W2 is a factor of, and positively correlated to, the second feedback capacitance C₂.

In operation, the sensing device 5, or specifically the sensing component 20, detects a capacitance C_{F} in response to a touch event of an object 15 on the sensing device 5. During the touch event, the object 15, the substrate 24 and the sensing unit 50 constitute an amplifier circuit shown in FIG. 5B.

FIG. 5B is a circuit diagram of an amplifier circuit 55, in a small-signal mode, of the sensing device 5 shown in FIG. 5A. Referring to FIG. 5B, the amplifier circuit 55 is similar to the amplifier circuit 35 described and illustrated with reference to FIG. 3B except that, for example, the amplifier circuit 55 further includes the second feedback capacitor C₂ and the capacitor C_{P2}.

The second feedback capacitor C₂ is coupled between the second input and the output of the amplifier OP. The second feedback capacitor C₂ establishes a second feedback path between the second input and the output of the amplifier OP.

The capacitor C_{P2} is coupled between the output of the amplifier OP and the reference ground GND.

The amplifier OP receives the trigger signal Vin2 at its second input, amplifies the trigger signal Vin2, and outputs the detection signal Vout at its output. The detection signal Vout and the trigger signal Vin2 have a relationship in equation (4) below.

$$\frac{Vout}{Vin 2} = - [ \frac{{C}_{in}}{( \frac{G + 1}{G} ) \times ( {C}_{1} + {C}_{2} ) + \frac{{C}_{F}}{G} + \frac{( \frac{{C}_{PF} \times {C}_{JUN}}{{C}_{PF} + {C}_{JUN}} )}{G}} ] \qquad equation ( 4 )$$

Similar to those described and illustrated with reference to FIG. 2B, in the embodiment of FIG. 5B, the gain of the amplifier circuit 55 is enhanced by introducing the second capacitor C_{JUN} in serial connection with the first capacitor C_{PF} with respect to the second input of the amplifier OP. The touch sensitivity of the sensing device 5 is thereby enhanced.

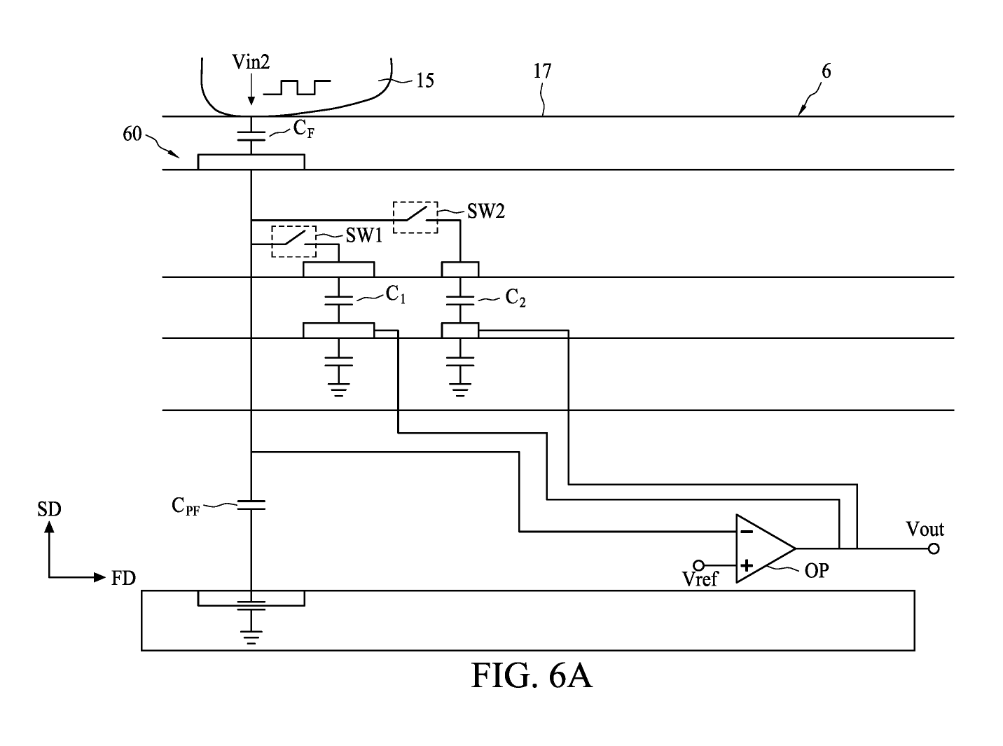

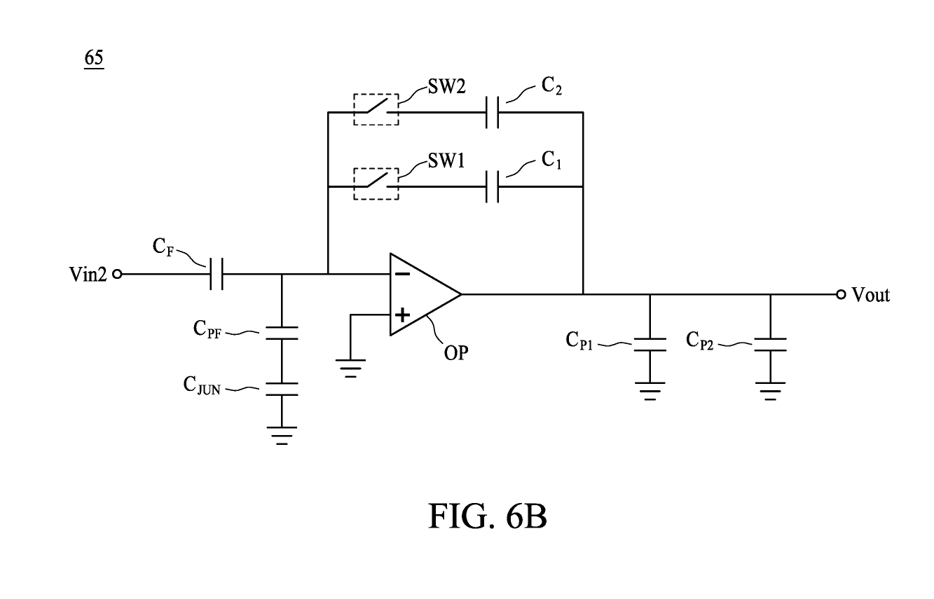

FIG. 6A is a schematic diagram of a sensing unit 60 in a sensing device 6, in accordance with an embodiment of the present disclosure. Referring to FIG. 6, the sensing device 6 is similar to the sensing device 5 described and illustrated with reference to FIG. 5A except, for example, sensing units 60 of the sensing device 6. The sensing unit 60 is similar to the sensing unit 50 described and illustrated with reference to FIG. 5A except that, for example, the sensing unit 60 further includes a first feedback switch SW1 and a second feedback switch SW2.

The first feedback switch SW1 is connected in series with the first feedback capacitor C₁ between the second input and the output of the amplifier OP. Moreover, the first feedback switch SW1 is selectively conducted in response to a controlled signal, thereby selectively disconnecting the first feedback path established by the first feedback capacitor C₁.

The second feedback switch SW2 is connected in series with the second feedback capacitor C₂ between the second input and the output of the amplifier OP. Moreover, the second feedback switch SW2 is selectively conducted in response to the controlled signal, thereby selectively disconnecting the second feedback path established by the second feedback capacitor C_{2.}

Furthermore, in response to the controlled signal, at least one of the first and second feedback switches SW1 and SW2 is conducted. Such operation will be described in detail in the following text.

In operation, the sensing device 6, or specifically the sensing component 20, detects a capacitance C_{F} in response to a touch event of an object 15 on the sensing device 6. During the touch event, a trigger signal Vin2 is input from the outside of the sensing device 3 in response to the touch event, and is coupled via the capacitor C_{F} to the second input of the amplifier OP. Moreover, during the touch event, the object 15, the substrate 24 and the sensing unit 60 constitute an amplifier circuit shown in FIG. 6B.

FIG. 6B is a circuit diagram of an amplifier circuit 65, in a small-signal mode, of the sensing device 60 shown in FIG. 6B. Referring to FIG. 6B, the amplifier circuit 65 is similar to the amplifier circuit 55 described and illustrated with reference to FIG. 5B except that, for example, the amplifier circuit 65 further includes the first and second feedback switches SW1 and SW2.

In the present embodiment, touch sensitivity of the sensing device 6 can be selected by a user. For example, assuming that the first feedback capacitance C₁ is larger than the second feedback capacitance C₂, if the user thinks that the current touch sensitivity is not high enough, the sensing device 6 is adjusted such that the first feedback switch SW1 is not conducted in response to a controlled signal while the second feedback switch SW2 is conducted in response to the controlled signal. Due to the relatively small second feedback capacitance C₂, the touch sensitivity in such arrangement is tuned up. Contrarily, if the user thinks that the current touch sensitivity is too high, the sensing device 6 is adjusted such that the first feedback switch SW1 is conducted in response to a controlled signal while the second feedback switch SW2 is not conducted in response to the controlled signal. Due to the relatively large first feedback capacitance C₁, the touch sensitivity in such arrangement is tuned down.

Moreover, in some embodiments, the first and second feedback switches SW1 and SW2 are conducted in response to a controlled signal. As such, the amplifier circuit 65 is substantially the same as the amplifier circuit 55 described and illustrated with reference to FIG. 5B.

Furthermore, in an embodiment, the first feedback capacitance C₁ is smaller than or equal to the second feedback capacitance C₂. Operation of such embodiment is similar to the above embodiment, and therefore is omitted herein.

In the present embodiment, by introducing the first and second feedback switches SW1 and SW2, a user can adjust the touch sensitivity of the sensing device 6.

Moreover, similar to those described and illustrated with reference to FIG. 2B, in the embodiment of FIG. 6B, the gain of the amplifier circuit 65 is enhanced by introducing the second capacitor C_{JUN} in serial connection with the first capacitor C_{PF} with respect to the second input of the amplifier OP. The touch sensitivity of the sensing device 6 is thus enhanced.

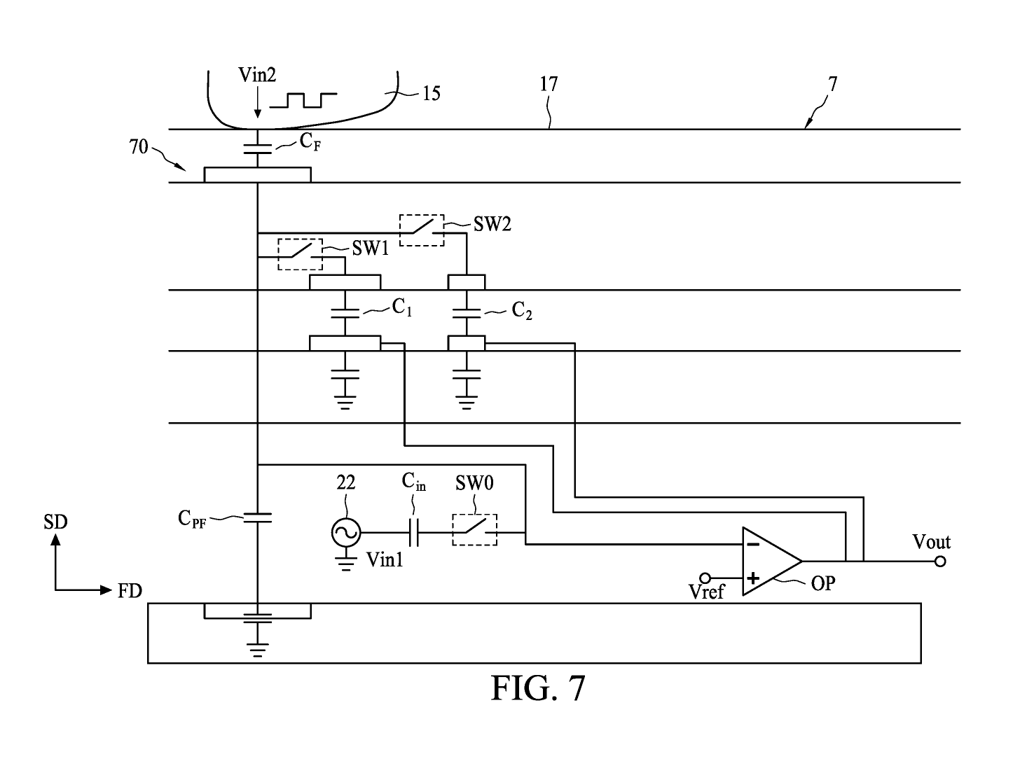

FIG. 7 is a schematic diagram of a sensing unit 70 in a sensing device 7, in accordance with an embodiment of the present disclosure. Referring to FIG. 7, the sensing device 7 is similar to the sensing device 6 described and illustrated with reference to FIG. 6A except that, for example, the sensing device 7 further includes a signal source 22, a capacitor Cᵢₙ, a signal source switch SW0 and a sensing unit 70.

Operation of the signal source switch SW0 is substantially the same as that of the signal source switch SW0 described and illustrated with reference to FIG. 4. Operations of the first and second feedback switches SW1 and SW2 are substantially the same as that of the first and second feedback switches SW1 and SW2 described and illustrated with reference to FIG. 6A except that, for example, the first and second feedback switches SW1 and SW2 of the sensing unit 70 are conducted in response to an event that a trigger signal (such as a trigger signal Vin2) is input from the outside of the sensing device 7, and are not conducted in response to an event that a trigger signal is a source trigger signal Vin1 provided by the signal source 22. As a result, the first and second feedback switches SW1 and SW2 are not conducted in response to a controlled signal when the signal source switch SW0 is conducted in response to the controlled signal. Moreover, when the signal source switch SW0 is not conducted in response to a controlled signal, at least one of the first and second feedback switches SW1 and SW2 is conducted in response to the controlled signal.

In the case that the first and second feedback switches SW1 and SW2 are not conducted in response to a controlled signal while the signal source switch SW0 is conducted in response to the controlled signal, the amplifier circuit, in a small-signal mode, of the sensing device 7 is substantially the same as the amplifier circuit 25 described and illustrated with reference to FIG. 2B.

In the case that the first feedback switch SW1 is conducted in response to a controlled signal while the second feedback switch SW2 and the signal source switch SW0 are not conducted in response to the controlled signal, the amplifier circuit, in a small-signal mode, of the sensing device 7 is substantially the same as the amplifier circuit 35 described and illustrated with reference to FIG. 3B.

In the case that the first feedback switch SW1 and the signal source switch SW0 are not conducted in response to a controlled signal while the second feedback switch SW2 is conducted in response to the controlled signal, the amplifier circuit, in a small-signal mode, of the sensing device 7 is substantially the same as the amplifier circuit 35 described and illustrated with reference to FIG. 3B except that, for example, instead of the first feedback capacitor C₁, the second feedback capacitor C₂ is coupled between the second input and the output of the amplifier OP.

In the case that the first and second feedback switches SW1 and SW2 are conducted in response to a controlled signal while the signal source switch SW0 is not conducted in response to the controlled signal, the amplifier circuit, in a small-signal mode, of the sensing device 7 is substantially the same as the amplifier circuit 55 described and illustrated with reference to FIG. 5B.

In the present embodiment, by introducing the first and second feedback switches SW1 and SW2, a user can select the touch sensitivity of the sensing device 7.

Moreover, similar to those described and illustrated with reference to FIG. 2B, in the embodiment of FIG. 7, by introducing the second capacitor Q_{JUN} in serial connection with the first capacitor C_{PF} with respect to the second input of the amplifier OP, the touch sensitivity of the sensing device 7 is enhanced.

Furthermore, in the present embodiment, similar to those m described and illustrated with reference to FIG. 4, by introducing the first and second feedback switches SW1 and SW2 and the source signal switch SW0, a user can select a source of a trigger signal. Therefore, the sensing device 7 provides a relatively flexible selection of signal source.

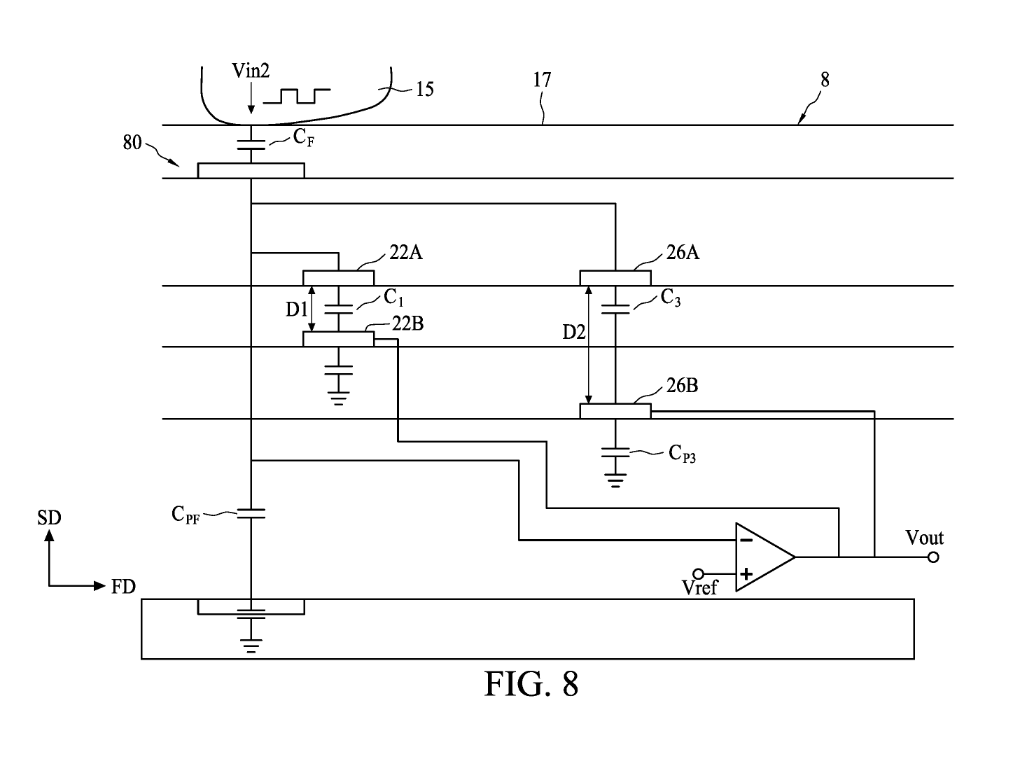

FIG. 8 is a schematic diagram of a sensing unit 80 in a sensing device 8, in accordance with an embodiment of the present disclosure. Referring to FIG. 8, the sensing device 8 is similar to the sensing device 3 described and illustrated with reference to FIG. 3A except, for example, sensing units 80 of the sensing device 8. The sensing unit 80 is similar to the sensing unit 30 described and illustrated with reference to FIG. 3A except that, for example, the sensing unit 80 further includes a third pair of conductive components 26A and 26B. The third pair of conductive components 26A and 26B extends in the first direction FD, and defines a third feedback capacitance C₃. The third feedback capacitor C₃ establishes a third feedback path between a second input and an output of an amplifier OP.

The conductive component 26A is arranged (or formed) in the second patterned conductive layer, and extends in the first direction FD. The conductive component 26A is coupled to the sensing component 20 and the substrate 24. The conductive component 26A includes a material selected from, but is not limited to, poly or metal.

The conductive component 26B is arranged in a fourth patterned conductive layer, and extends in the first direction FD. The conductive components 26A and 26B are separated from each another in the second direction SD by, for example, dielectric materials. The conductive component 26B is coupled to an output of an amplifier OP. Moreover, the conductive component 26B and the substrate 24 define a capacitance C_{P3}. The conductive component 26B includes a material selected from, but is not limited to, poly or metal.

The conductive components 22A and 22B are separated in the second direction SD by a distance D1. Specifically, a patterned conductive layer where the conductive component 22A is disposed is immediately adjacent to a patterned conductive layer where the conductive component 22B is disposed.

The conductive components 26A and 26B are separated in the second direction SD by a distance D2 different from the distance D1. Specifically, the conductive components 26A and 26B are separated from each another by at least one intermediate patterned conductive layer.

For example, in a semiconductor manufacturing process, the conductive component 22A is made of a metal-4 layer (M4), and the conductive component 22B is made of a metal-3 layer (M3). The conductive component 26A is also made of a metal-4 layer while the conductive component 26B is made of a metal-2 layer (M2). Therefore, the distance D2 is longer than the distance D1.

In the present embodiment, the conductive components 22A and 26A are arranged in the same patterned conductive layer. However, in some embodiments, the conductive components 22A and 26A are not arranged in the same patterned conductive layer.

In the present embodiment, the distance D1 is a factor of, and negatively correlated to, the first feedback capacitance C₁. The distance D2 is a factor of, and negatively correlated to, the third feedback capacitance C₃. Since the distances D1 and D2 are different from each other, the first feedback capacitance C₁ is different from the third feedback capacitance C₃.

Moreover, in some embodiments, similar to those described and illustrated with reference to FIG. 5A, the size of the third pair of conductive components 26A and 26B is different from that of the first pair of conductive components 22A and 22B in the first direction FD.

Moreover, in some embodiments, similar to those described and illustrated with reference to FIG. 5A, in operation, the sensing device 8, or specifically the sensing component 20, detects a capacitance C_{F} in response to a touch event of an object 15 on the sensing device 8. During the touch event, the object 15, the substrate 24 and the sensing unit 80 constitute an amplifier circuit.

An amplifier circuit (not shown), in small-signal mode, of the sensing device 8 is similar to the amplifier circuit 55 described and illustrated with reference to FIG. 5B except that, for example, the second feedback capacitance C₂ in FIG, 5B is replaced with the third feedback capacitance C₃.

Similar to those described and illustrated with reference to FIG. 2B, an equivalent capacitance between a second input and an output of an amplifier OP is the sum of the first and third feedback capacitances C₁ and C₃. As a result, the voltage level at the output of the amplifier OP is a function of the equivalent capacitance.

Similar to those described and illustrated with reference to FIG. 2B, in the embodiment of FIG. 8, by introducing the second capacitor C_{JUN} in serial connection with the first capacitor C_{PF} with respect to the second input of the amplifier OP, the touch sensitivity of the sensing device 8 is enhanced.

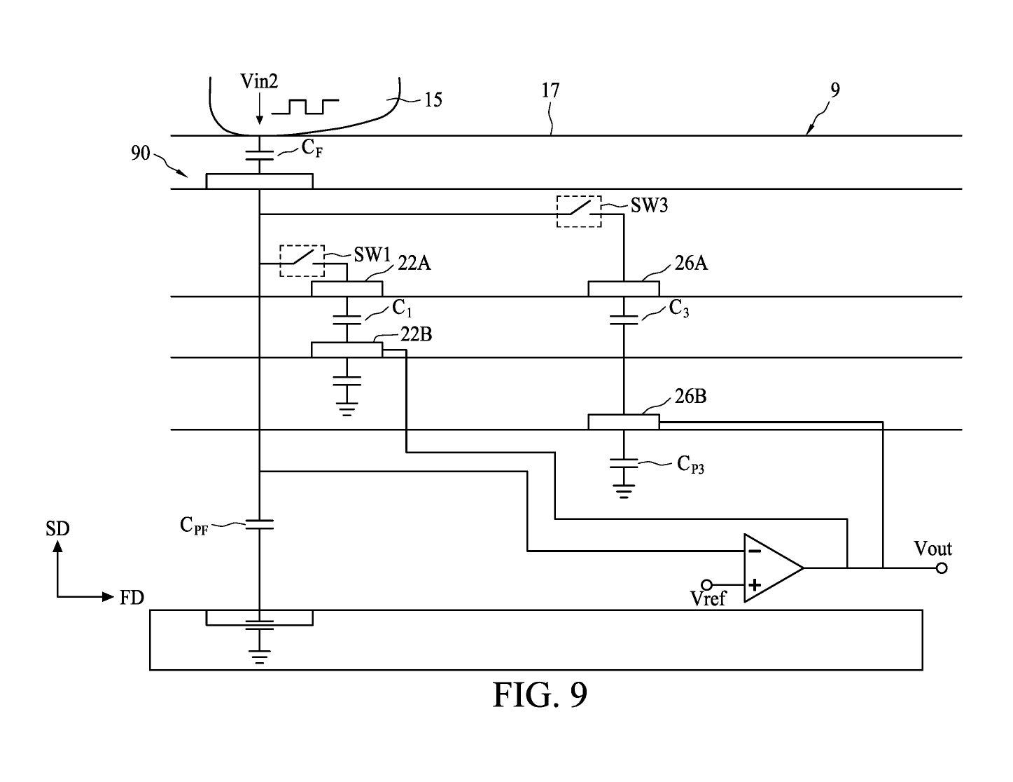

FIG. 9 is a schematic diagram of a sensing unit 9 in a sensing device 9, in accordance with an embodiment of the present disclosure. Referring to FIG. 9, the sensing device 9 is similar to the sensing device 8 described and illustrated with reference to FIG. 8 except, for example, sensing units 90 of the sensing device 9. The sensing unit 90 is similar to the sensing unit 80 described and illustrated with reference to FIG. 8 except that, for example, the sensing unit 90 further includes a first feedback switch SW1 and a third feedback switch SW3.

Operation of the first feedback switch SW1 is substantially the same as that of the first feedback switch SW1 described and illustrated with reference to FIG. 6A.

The third feedback switch SW3 is connected in series with a third feedback capacitor C₃ between a second input and an output of an amplifier OP. Moreover, the third feedback switch SW3 is selectively conducted in response to a controlled signal, thereby selectively disconnecting the third feedback path established by the third feedback capacitor C₃.

Moreover, in response to the controlled signal, at least one of the first and third feedback switches SW1 and SW3 is conducted.

Operation of the first and third feedback switches SW1 and SW3 is substantially the same as that of the first and second feedback switches SW1 and SW2 described and illustrated with reference to FIG. 6A.

Similar to those described and illustrated with reference to FIG. 6A, in the present embodiment, by introducing the first and third feedback switches SW1 and SW3, a user can adjust the touch sensitivity of the sensing device 9.

Moreover, similar to those described and illustrated with reference to FIG. 2B, in the embodiment of FIG. 9, by introducing the second capacitor C_{JUN} in serial connection with the first capacitor C_{PF} with respect to the second input of the amplifier OP, the touch sensitivity of the sensing device 9 is enhanced.

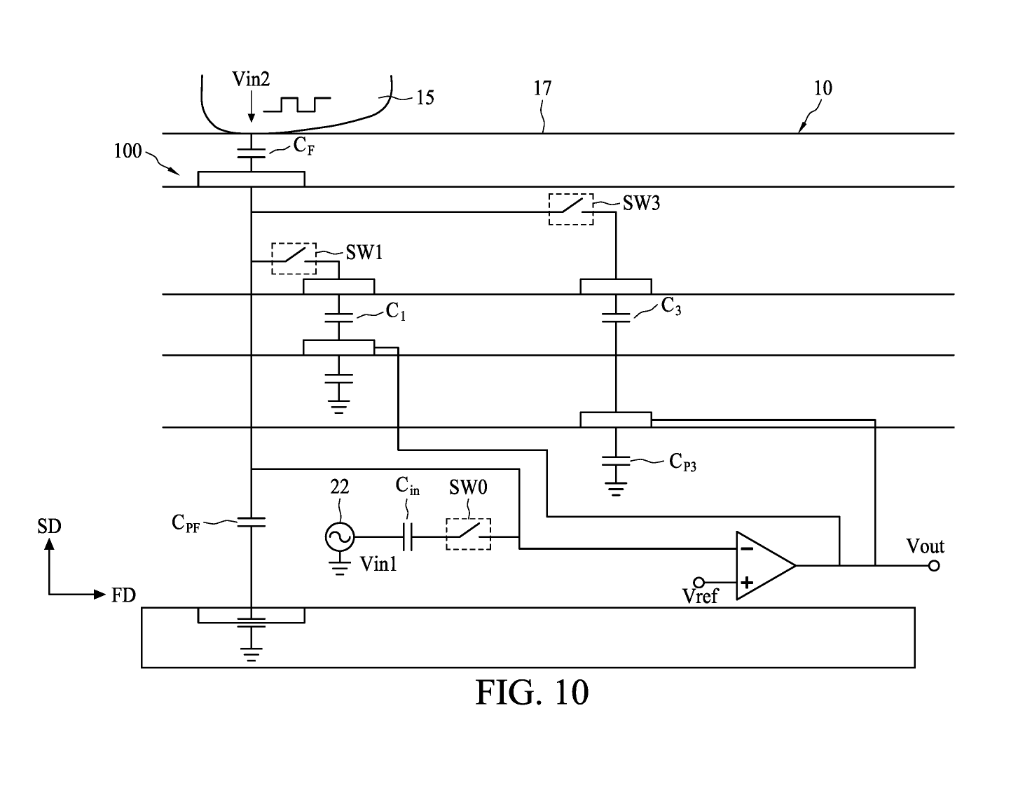

FIG. 10 is a schematic diagram of a sensing unit 100 in a sensing device 10, in accordance with an embodiment of the present disclosure. Referring to FIG. 10, the sensing device 10 is similar to the sensing device 9 described and illustrated with reference to FIG. 9 except that, for example, the sensing device 10 further includes a signal source 22, a capacitor Cᵢₙ, a signal source switch SW0 and the sensing unit 100.

Operation of the signal source switch SW0 is substantially the same as that of the signal source switch SW0 described and illustrated with reference to FIG. 4. Operation of the first and third feedback switches SW1 and SW3 of the sensing unit 100 is substantially the same as that of the first and third feedback switches SW1 and SW3 of the sensing unit 90 described and illustrated with reference to FIG. 9 except that, for example, the first and third feedback switches SW1 and SW3 of the sensing unit 100 are conducted in response to an event that a trigger signal (such as a trigger signal Vin2) is output from the outside of the sensing device 10, and not conducted in response to an event that a trigger signal is a source trigger signal Vin1 provided by the signal source 22. As a result, when the signal source switch SW0 is conducted in response to a controlled signal, the first and third feedback switches SW1 and SW3 are not conducted in response to the controlled signal. Contrarily, when the signal source switch SW0 is not conducted in response to a controlled signal, at least one of the first and third feedback switches SW1 and SW3 is conducted in response to the controlled signal.

In the case that the first and third feedback switches SW1 and SW3 are not conducted in response to a controlled signal while the signal source switch SW0 is conducted in response to the controlled signal, the amplifier circuit, in a small-signal mode, of the sensing device 10 is substantially the same as the amplifier circuit 25 described and illustrated with reference to FIG. 2B.

In the case that the first feedback switch SW1 is conducted in response to a controlled signal while the third feedback switch SW3 and the signal source switch SW0 are not conducted in response to the controlled signal, the amplifier circuit, in a small-signal mode, of the sensing device 10 is substantially the same as the amplifier circuit 35 described and illustrated with reference to FIG. 3B.

In the case that the first feedback switch SW1 and the signal source switch SW0 are not conducted in response to a controlled signal while the third feedback switch SW3 is conducted in response to the controlled signal, the amplifier circuit, in a small-signal mode, of the sensing device 10 is substantially the same as the amplifier circuit 35 described and illustrated with reference to FIG. 3B except that, for example, instead of the first feedback capacitor C₁, the third feedback capacitor C₃ is coupled between the second input and the output of the amplifier OP.

In the case that the first and third feedback switches SW1 and SW3 are conducted in response to a controlled signal while the signal source switch SW0 is not conducted in response to the controlled signal, the amplifier circuit, in a small-signal mode, of the sensing device 10 is substantially the same as the amplifier circuit of the sensing device 8 described and illustrated with reference to FIG. 8.

In the present embodiment, by introducing the first and third feedback switches SW1 and SW3, a user can adjust the touch sensitivity of the sensing device 10.

Moreover, similar to those described and illustrated with reference to FIG. 2B, in the embodiment of FIG. 10, by introducing the second capacitor C_{JUN} in serial connection with the first capacitor C_{PF} with respect to the second input of the amplifier OP, the touch sensitivity of the sensing device 10 is enhanced.

Furthermore, similar to those described and illustrated with reference to FIG. 4, in the present embodiment, by introducing the first and third feedback switches SW1 and SW3 and the source signal switch SW0, a user can select a source of a trigger signal. Therefore, the sensing device 10 provides a relatively flexible selection of source signal.

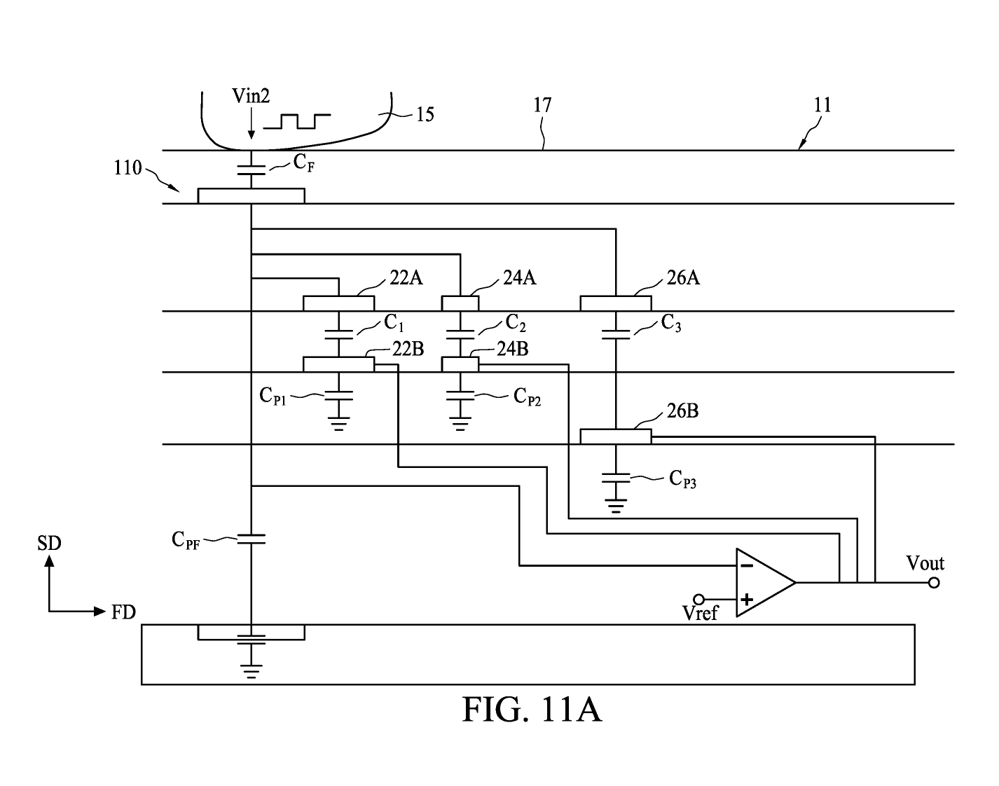

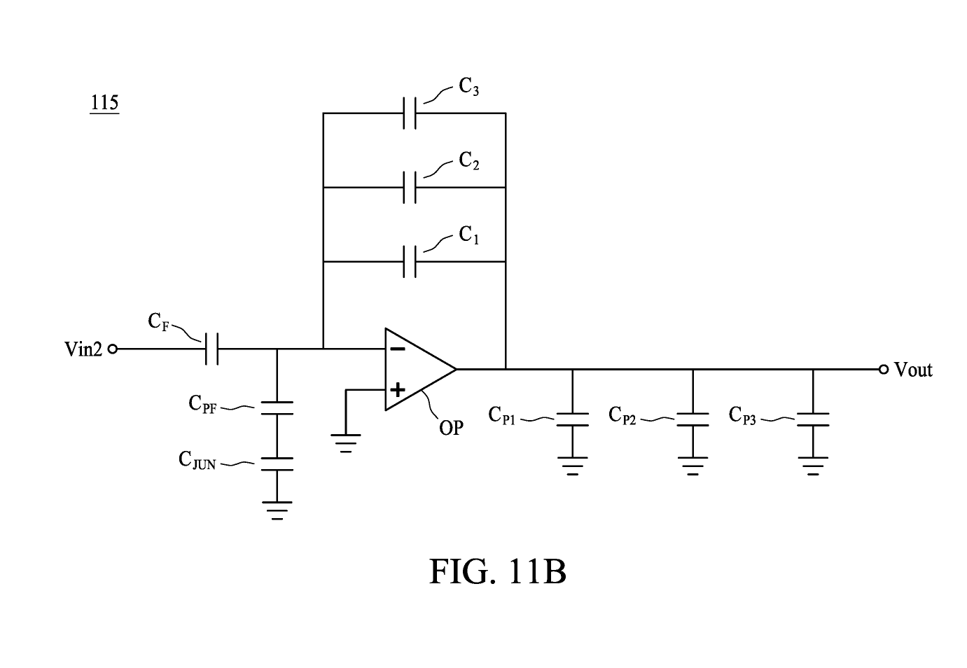

FIG. 11A is a schematic diagram of a sensing unit 110 in a sensing device 11, in accordance with an embodiment of the represent disclosure. Referring to FIG. 11A, the sensing device 11 is similar to the sensing device 5 described and illustrated with reference to FIG. 5A except, for example, a sensing unit 110. The sensing unit 110 is similar to the sensing unit 50 described and illustrated with reference to FIG. 5A except that, for example, the sensing unit 110 further includes a third pair of conductive components 26A and 26B. The third pair of conductive components 26A and 26B of the sensing device 11 is substantially the same as the third pair of conductive components 26A and 26B of the sensing device 8 described and illustrated with reference to FIG. 8.

In operation, the sensing device 11, or specifically the sensing component 20 thereof, detects a capacitance C_{F} in response to a touch event of an object 15 on the sensing device 11. During the touch event, the object 15, the substrate 24 and the sensing unit 110 constitute an amplifier circuit shown in FIG. 11B.

FIG. 11B is a circuit diagram of an amplifier circuit 115, in a small-signal mode, of the sensing device 11 shown in FIG. 11A. Referring to FIG. 11B, the amplifier circuit 115 is similar to the amplifier circuit 55 described and illustrated with reference to FIG. 5B except that, for example, the amplifier circuit 115 further includes a third feedback capacitor C₃. Moreover, the third feedback capacitor C₃ establishes a third feedback path between a second input and an output of an amplifier OP.

The first feedback capacitor C₁, the second feedback capacitor C₂ and the third feedback capacitor C₃ are connected in parallel between the second input and the output of the amplifier OP.

The amplifier OP receives a trigger signal Vin 2 at its second input, amplifies the trigger signal Vin2, and outputs a detection signal Vout at its output. The detection signal Vout and the trigger signal Vin2 have a relationship in equation (5) below.

$$\frac{Vout}{Vin 2} = - [ \frac{{C}_{in}}{( \frac{G + 1}{G} ) \times ( {C}_{1} + {C}_{2} + {C}_{3} ) + \frac{{C}_{F}}{G} + \frac{( \frac{{C}_{PF} \times {C}_{JUN}}{{C}_{PF} + {C}_{JUN}} )}{G}} ] \qquad equation ( 5 )$$

Similar to those described and illustrated with reference to FIG. 2B, an equivalent capacitance between the second input and the output of the amplifier OP is the sum of the first, second and third capacitances C₁, C₂ and C₃. As a result, the voltage level at the output of the amplifier OP is a function of the equivalent capacitance.

Similar to those described and illustrated with reference to FIG. 2B, in the embodiment of FIG. 10, the gain of the amplifier circuit 115 is enhanced by introducing the second capacitor C_{JUN} in serial connection with the first capacitor C_{PF} with respect to the second input of the amplifier OP. The touch sensitivity of the sensing device 11 is thus enhanced.

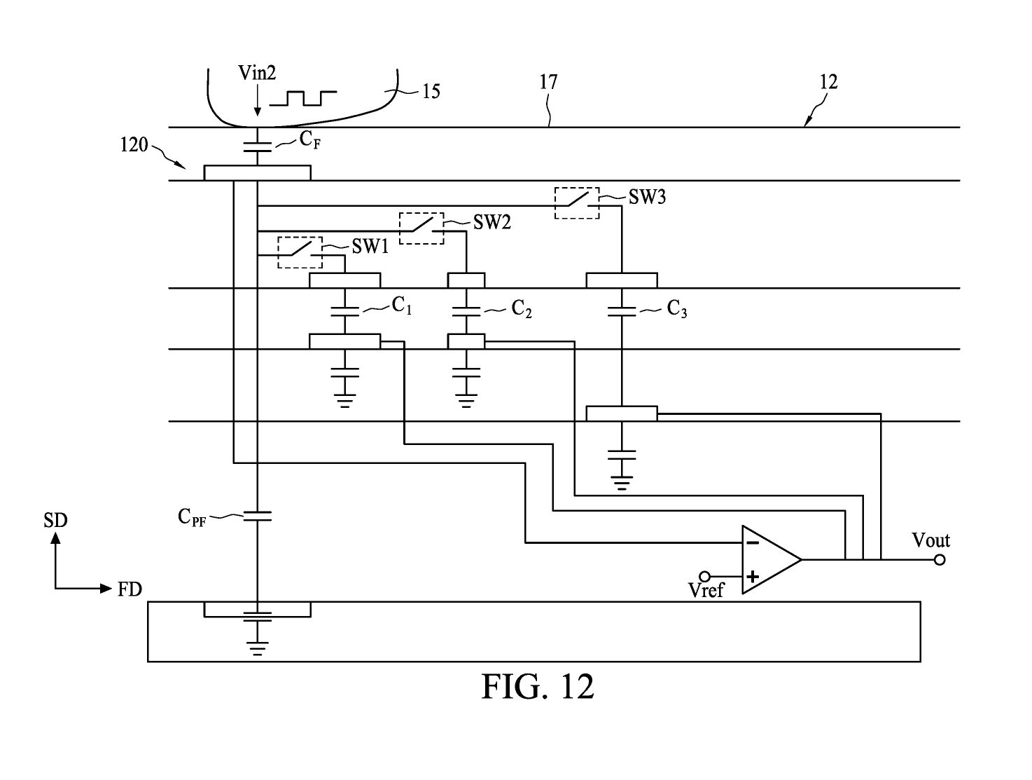

FIG. 12 is a schematic diagram of a sensing unit 120 in a sensing device 12, in accordance with an embodiment of the represent disclosure. Referring to FIG. 12, the sensing device 12 is similar to the sensing device 11 described and illustrated with reference to FIG. 11A except, for example, sensing units 120 of the sensing device 12. The sensing unit 120 is similar to the sensing unit 110 described and illustrated with reference to FIG. 11A except that, for example, the sensing unit 120 further includes a first feedback switch SW1, a second feedback switch SW2 and a third feedback switch SW3.

Operation of the first, second and third feedback switches SW1, SW2 and SW3 is substantially the same as that of the first and second feedback switches SW1 and SW2 described and illustrated with reference to FIG. 6A, and substantially the same as that of the first and third feedback switches SW1 and SW3 described and illustrated with reference to FIG. 9. As a result, in response to a controlled signal, at least one of the first feedback switch SW1, the second feedback switch SW2 or the third feedback switch SW3 is conducted.

Similar to those described and illustrated with reference to FIG. 6B, in the present embodiment, by introducing the first, second and third feedback switches SW1, SW2 and SW3, a user can select the touch sensitivity of the sensing device 12.

Moreover, similar to those described and illustrated with reference to FIG. 2B, in the present embodiment, by introducing the second capacitor C_{JUN} in serial connection with the first capacitor C_{PF} with respect to the second input of the amplifier OP, the touch sensitivity of the sensing device 12 is enhanced.

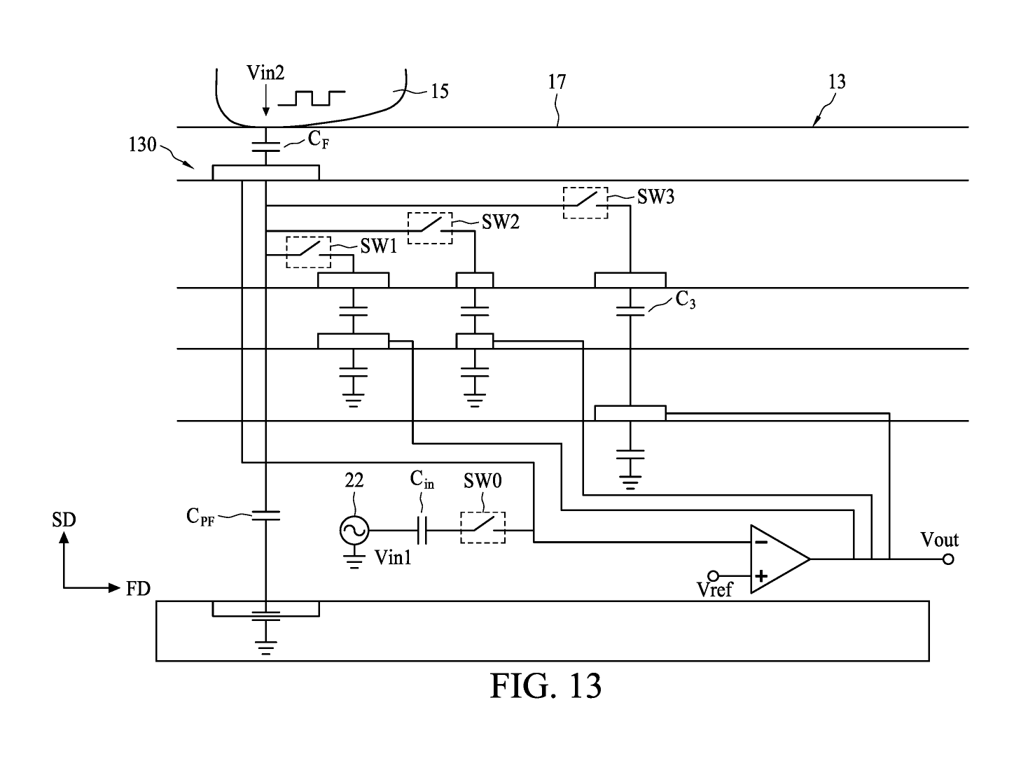

FIG. 13 is a schematic diagram of a sensing unit 130 in a sensing device 13, in accordance with an embodiment of the represent disclosure. Referring to FIG. 13, the sensing device 13 is similar to the sensing device 12 described and illustrated with reference to FIG. 12 except that, for example, the sensing device 13 further includes a signal source 22, a capacitor Cᵢₙ, a signal source switch SW0 and a sensing unit 130.

Operation of the signal source switch SW0 is substantially the same as the signal source switch SW0 described and illustrated with reference to FIG. 4. Operation of the first, second and third feedback switches SW1, SW2 and SW3 is substantially the same as the first, second and third feedback switches SW1, SW2 and SW3 described and illustrated with reference to FIG. 12 except that, for example, the first, second and third feedback switches SW1, SW2 and SW3 are conducted in response to an event that a trigger signal (such as a trigger signal Vin2) is input from the outside of the sensing device 13, and not conducted in response to another event that a trigger signal is a source trigger signal Vin 1 provided by the signal source 22. As a result, when the signal source switch SW0 is conducted in response to a controlled signal, the first, second and third feedback switches SW1, SW2 and SW3 are not conducted in response to the controlled signal. However, when the signal source switch SW0 is not conducted in response to a controlled signal, at least one of the first, second or third feedback switches SW1, SW2 or SW3 is conducted in response to the controlled signal.

In the case that the first, second and third feedback switches SW1, SW2 and SW3 are not conducted in response to a controlled signal while the signal source switch SW0 is conducted in response to the controlled signal, the amplifier circuit, in a small-signal mode, of the sensing device 13 is substantially the same as the amplifier circuit 25 described and illustrated with reference to FIG. 2B.

In the case that the first feedback switch SW1 is conducted in response to a controlled signal while the second and third feedback switches SW2 and SW3 and the signal source switch SW0 are not conducted in response to the controlled signal, the amplifier circuit, in a small-signal mode, of the sensing device 13 is substantially the same as the amplifier circuit 35 described and illustrated with reference to FIG. 3B.

In the case that the second feedback switch SW2 is conducted in response to a controlled signal while the first and third feedback switches SW1 and SW3 and the signal source switch SW0 are not conducted in response to the controlled signal, the amplifier circuit, in a small-signal mode, of the sensing device 13 is similar to the amplifier circuit 35 except that, for example, referring to FIG. 3B, instead of the first feedback capacitor C₁, the second feedback capacitor C₂ is coupled between the second input and the output of the amplifier OP.

In the case that the third feedback switch SW3 is conducted in response to a controlled signal while the first and second feedback switches SW1 and SW2 and the signal source switch SW0 are not conducted in response to the controlled signal, the amplifier circuit, in a small-signal mode, of the sensing device 13 is similar to the amplifier circuit 35 except that, for example, referring to FIG. 3B, instead of the first feedback capacitor C₁, the third feedback capacitor C₃ is coupled between the second input and the output of the amplifier OP.

In the case that the first and second switches SW1 and SW2 are conducted in response to a controlled signal while the third feedback switch SW3 and the signal source switch SW0 are not conducted in response to the controlled signal, the amplifier circuit, in a small-signal mode, of the sensing device 13 is substantially the same as the amplifier circuit 55 described and illustrated with reference to FIG. 5B.

In the case that, the first and third switches SW1 and SW3 are conducted in response to a controlled signal while the second feedback switch SW2 and the signal source switch SW0 are not conducted in response to the controlled signal, the amplifier circuit, in a small-signal mode, of the sensing device 13 is substantially the same as the amplifier circuit of the sensing device 8 described with reference to FIG. 8.

In the case that the first, second and third feedback switches SW1, SW2 and SW3 are conducted in response to a controlled signal while the signal source switch SW0 is not conducted in response to the controlled signal, the amplifier circuit, in a small-signal mode, of the sensing device 13 is substantially the same as the amplifier circuit 115 of the sensing device 11 described and illustrated with reference to FIG. 11B.

In the present embodiment, by introducing the first, second and third feedback switches SW1, SW2 and SW3, a user can select the touch sensitivity of the sensing device 13.

Moreover, similar to those described and illustrated with reference to FIG. 2B, in the present embodiment, by introducing the second capacitor C_{JUN} in serial connection with the first capacitor C_{PF} with respect to the second input of the amplifier OP, the touch sensitivity of the sensing device 13 is enhanced.

Furthermore, similar to those described and illustrated with reference to FIG. 4, in the present embodiment, by introducing the first, second and third feedback switches SW1, SW2 and SW3 and the source signal switch SW0, the user can select a source of a trigger signal. Therefore, the sensing device 13 provides a relatively flexible selection of signal source.

Although in language specific to structural features and/or methodological acts of the subject matter has been described, it is to be understood that the appended claims are not necessarily limited to the subject matter defined and the specific features or acts described above. Rather, the specific features and acts described above as exemplary forms of implementing the claims are disclosed.

Various operations of embodiments are provided herein. The order in which some or all of the operations are described should not be construed as to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

It will be appreciated that layers, features, elements, etc. depicted herein are illustrated with particular dimensions relative to one another, such as structural dimensions or orientations, for example, for purposes of simplicity and ease of understanding and that actual dimensions of the same differ substantially from that illustrated herein, in some embodiments.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A sensing device, comprising:
a sensing component, configured to extend in a first direction, and detect a capacitance in response to a touch event of an object; and
a substrate, configured to define a first capacitance with the sensing component, and provide a second capacitance, wherein the first capacitance and the second capacitance are connected in series with respect to the sensing component.

2. The sensing device of claim 1, further comprising:
a signal source, configured to supply a source trigger signal; and
an amplifier, having an input coupled to the sensing component, and configured to receive the source trigger signal.

3. The sensing device of claim 1, further comprising:
an amplifier, having an input coupled to the sensing component, and configured to receive a trigger signal from the outside of the sensing device; and
a first pair of conductive components, formed in patterned layers different from the sensing component, extending in the first direction, and defining a first feedback capacitance in a second direction, the first feedback capacitance coupled between an input and an output of the amplifier.

4. The sensing device of claim 1, further comprising:
an amplifier, having an input coupled to the sensing component, and configured to receive a trigger signal;
a signal source, configured to supply a source trigger signal;
a first pair of conductive components, formed in patterned layers different from the sensing component, extending in the first direction, and defining a first feedback capacitance in a second direction, the first feedback capacitance coupled between an input and an output of the amplifier;
a signal source switch, coupled between the signal source and the input of the amplifier, and configured to be not conducted in response to an event that the trigger signal is from the outside of the sensing device while to be conducted in response to an event that the trigger signal is the source trigger signal provided by the signal source; and
a first feedback switch, configured to be connected in series with the first feedback capacitance between the output and the input of the amplifier, and configured to be conducted in response to an event that the trigger signal is from the outside of the sensing device while to be not conducted in response to an event that the trigger signal is the source trigger signal provided by the signal source.

5. The sensing device of claim 3, wherein the first pair of conductive components has a first size in the first direction, the sensing device further comprising:
a second pair of conductive components, configured to extend in the first direction, having a second size in the first direction, and defining a second feedback capacitance in the second direction, wherein the second feedback capacitance and the first feedback capacitance are connected in parallel between the input and the output of the amplifier.

6. The sensing device of claim 5, further comprising:
a first feedback switch, configured to be connected in series with the first feedback capacitance between the output and the input of the amplifier, and configured to be selectively conducted; and
a second feedback switch, configured to be connected in series with the second feedback capacitance between the output and the input of the amplifier, and configured to be selectively conducted,
wherein at least one of the first feedback switch and the second feedback switch is conducted.

7. The sensing device of claim 1, further comprising:
an amplifier, having an input coupled to the sensing component, and configured to receive a trigger signal;
a signal source, configured to supply a source trigger signal;
a first pair of conductive components, formed in patterned layers different from the sensing component, extending in the first direction, having a first size in the first direction, and defining a first feedback capacitance in a second direction, wherein the first feedback capacitance is coupled between the input and an output of the amplifier;
a second pair of conductive components, configured to extend in the first direction, having a second size in the first direction, and defining a second feedback capacitance in the second direction, wherein the second feedback capacitance and the first feedback capacitance are connected in parallel between the input and the output of the amplifier;
a signal source switch, coupled between the signal source and the input of the amplifier, and configured to be not conducted in response to an event that the trigger signal is from the outside of the sensing device while to be conducted in response to an event that the trigger signal is the source trigger signal provided by the signal source;
a first feedback switch, configured to be connected in series with the first feedback capacitance between the output and the input of the amplifier, and configured to be not conducted in response to an event that the trigger signal is the source trigger signal provided by the signal source; and
a second feedback switch, configured to be connected in series with the second feedback capacitance between the output and the input of the amplifier, and configured to be not conducted in response to an event that the trigger signal is the source trigger signal provided by the signal source,
wherein at least one of the first feedback switch and the second feedback switch is conducted in response to an event that the trigger signal is from the outside of the sensing device.

8. The sensing device of claim 4, wherein the first pair of conductive components comprises a first conductive component and a second conductive component, which are spaced apart by a first distance in the second direction, the sensing device further comprising:
a third pair of conductive components, configured to extend in the first direction, and defining a third feedback capacitance in the second direction, wherein the third feedback capacitance is connected with the first feedback capacitance in parallel between the input and the output of the amplifier, the third pair of conductive components comprising a first conductive component and a second conductive component, which are spaced apart by a second distance different from the first distance in the second direction.

9. The sensing device of claim 8, further comprising:
a first feedback switch, configured to be connected in series with the first feedback capacitance between the output and the input of the amplifier, and configured to be selectively conducted; and
a third feedback switch, configured to be connected in series with the third feedback capacitance between the output and the input of the amplifier, and configured to be selectively conducted,
wherein at least one of the first feedback switch and the third feedback switch is conducted.

10. The sensing device of claim 1, further comprising:
an amplifier, having an input coupled to the sensing component, and configured to receive a trigger signal;
a signal source, configured to supply a source trigger signal;
a first pair of conductive components, arranged in patterned layers different from the sensing component, extending in the first direction, and defining a first feedback capacitance in a second direction, wherein the first feedback capacitance is coupled between the input and an output of the amplifier, the first pair of conductive components comprising a first conductive component and a second conductive component, which are spaced apart by a first distance in the second direction;
a third pair of conductive components, configured to extend in the first direction, and defining a third feedback capacitance in the second direction, wherein the third feedback capacitance is connected with the first feedback capacitance in parallel between the input and the output of the amplifier; the third pair of conductive components comprising a first conductive component and a second conductive component, which are spaced apart by a second distance different from the first distance in the second direction;
a signal source switch, coupled between the signal source and the input of the amplifier, and configured to be not conducted in response to an event that the trigger signal is from the outside of the sensing device while to be conducted in response to an event that the trigger signal is the source trigger signal provided by the signal source;
a first feedback switch, configured to be connected in series with the first feedback capacitance between the output and the input of the amplifier, and configured to be not conducted in response to an event that the trigger signal is the source trigger signal provided by the signal source; and
a third feedback switch, configured to be connected in series with the third feedback capacitance between the output and the input of the amplifier, and configured to be not conducted in response to an event that the trigger signal is the source trigger signal provided by the signal source,
wherein when the signal source switch is not conducted, at least one of the first feedback switch and the third feedback switch is conducted.

11. The sensing device of claim 5, wherein the first pair of conductive components comprises a first conductive component and a second conductive component, which are spaced apart by a first distance in the second direction, the sensing device further comprising:
a third pair of conductive components, configured to extend in the first direction and defining a third feedback capacitance in the second direction, the third feedback capacitance connected with the first feedback capacitance in parallel between the input and the output of the amplifier, the third pair of conductive components comprising a first conductive component and a second conductive component, which are spaced apart by a second distance different from the first distance in the second direction.

12. The sensing device of claim 11, further comprising:
a first feedback switch, configured to be connected in series with the first feedback capacitance between the output and the input of the amplifier, and configured to be selectively conducted;
a second feedback switch, configured to be connected in series with the second feedback capacitance between the output and the input of the amplifier, and configured to be selectively conducted; and
a third feedback switch, configured to be connected in series with the third feedback capacitance between the output and the input of the amplifier, and configured to be selectively conducted,
wherein at least one of the first feedback switch, the second feedback switch and the third feedback switch is conducted.

13. The sensing device of claim 7, wherein the first pair of conductive components comprises a first conductive component and a second conductive component, which are spaced apart by a first distance in the second direction, the sensing device further comprising:
a third pair of conductive components, configured to extend in the first direction and defining a third feedback capacitance in the second direction, the third feedback capacitance connected with the first feedback capacitance in parallel between the input and the output of the amplifier, the third pair of conductive components comprising a first conductive component and a second conductive component, which are spaced apart by a second distance different from the first distance in the second direction; and
a third feedback switch, configured to be connected in series with the third feedback capacitance between the output and the input of the amplifier, and configured to be not conducted in response to an event that the trigger signal is the source trigger signal provided by the signal source,
wherein when the signal source switch is not conducted, at least one of the first feedback switch, the second feedback switch and the third feedback switch is conducted.

14. A sensing device, comprising:
a sensing component, configured to detect a capacitance in response to a touch event of an object on the sensing device;
a substrate, configured to define a first capacitance with the sensing component, and provide a second capacitance; and
an amplifier, having a output, wherein a voltage level at the output of the amplifier is a function of the first capacitance and the second capacitance.

15. The sensing device of claim 14, wherein the amplifier receives a trigger signal at an input of the amplifier, the voltage level at the output of the amplifier and the first and second capacitance having a relationship below:
$$\frac{Vout}{Vin 1} = - [ \frac{{C}_{in}}{{C}_{in} + {C}_{F} + ( \frac{{C}_{PF} \times {C}_{JUN}}{{C}_{PF} + {C}_{JUN}} )} ] \times G$$
where Vin1 represents a voltage level of the trigger signal, wherein the trigger signal is provided by a signal source of the sensing device, Vout represents the voltage level at the output of the amplifier, Cᵢₙ represents a capacitance of a capacitor, wherein the trigger signal is input to the input of the amplifier via the capacitor, G represents an open-loop gain of the amplifier, C_{F} represents the capacitance, C_{PF} represents the first capacitance, and C_{JUN} represents the second capacitance.

16. The sensing device of claim 14, further comprising:
a first pair of conductive components, defining a first feedback capacitance, the voltage level at the output of the amplifier is a function of the first feedback capacitance.

17. The sensing device of claim 16, wherein the amplifier receives a trigger signal at an input of the amplifier, the voltage level at the output of the amplifier and the first feedback capacitance having a relationship below:
$$\frac{Vout}{Vin 2} = - [ \frac{{C}_{in}}{( \frac{G + 1}{G} ) \times {C}_{1} + \frac{{C}_{F}}{G} + \frac{( \frac{{C}_{PF} \times {C}_{JUN}}{{C}_{PF} \times {C}_{JUN}} )}{G}} ]$$
where Vin2 represents a voltage level of the trigger signal, wherein the trigger signal is input from the outside of the sensing device, Vout represents the voltage level at the output of the amplifier, G represents an open-loop gain of the amplifier, C_{F} represents the capacitance, C_{PF} represents the first capacitance, C_{JUN} represents the second capacitance, and C₁ represents the first feedback capacitance.

18. The sensing device of claim 16, wherein the first pair of conductive components has a first size in a first direction, the first size being a factor of the first feedback capacitance, the sensing device further comprising:
a second pair of conductive components, having a second size in the first direction, and defining a second feedback capacitance, the second size being a factor of the second feedback capacitance,
wherein an equivalent capacitance between an input and the output of the amplifier is a sum of the first feedback capacitance and the second feedback capacitance, the voltage level at the output of the amplifier being a function of the equivalent capacitance,
wherein the amplifier receives a trigger signal at the input of the amplifier, the voltage level at the output of the amplifier and the equivalent capacitance having a relationship below:
$$\frac{Vout}{Vin 2} = - [ \frac{{C}_{in}}{( \frac{G + 1}{G} ) \times ( {C}_{1} + {C}_{2} ) + \frac{{C}_{F}}{G} + \frac{( \frac{{C}_{PF} \times {C}_{JUN}}{{C}_{PF} + {C}_{JUN}} )}{G}} ]$$
where Vin2 represents a voltage level of the trigger signal, wherein the trigger signal is input from the outside of the sensing device, Vout represents the voltage level at the output of the amplifier, G represents an open-loop gain of the amplifier, C_{F} represents the capacitance, C_{PF} represents the first capacitance, C_{JUN} represents the second capacitance, C₁ represents the first feedback capacitance, and C₂ represents the second feedback capacitance.

19. The sensing device of claim 16, the first pair of conductive components comprising a first conductive component and a second conductive component, which are spaced apart by a first distance in a second direction, the first distance being a factor of the first feedback capacitance, the sensing device further comprising:
a third pair of conductive components, configured to define a third feedback capacitance, the third pair of conductive components comprising a first conductive component and a second conductive component, which are spaced apart by a second distance different from the first distance in the second direction, the second distance being a factor of the third feedback capacitance,
wherein an equivalent capacitance between an input and the output of the amplifier is a sum of the first feedback capacitance and the third feedback capacitance, the voltage level at the output of the amplifier being a function of the equivalent capacitance.

20. The sensing device of claim 18, the first pair of conductive components comprising a first conductive component and a second conductive component, which are spaced apart by a first distance in a second direction, the first distance is a factor of the first feedback capacitance, the sensing device further comprising:
a third pair of conductive components, configured to define a third feedback capacitance, the third pair of conductive components comprising a first conductive component and a second conductive component, which are spaced apart by a second distance different from the first distance in the second direction, the second distance being a factor of the third feedback capacitance,
wherein an equivalent capacitance between the input and the output of the amplifier is a sum of the first feedback capacitance, the second feedback capacitance and the third feedback capacitance, the voltage level at the output of the amplifier being a function of the equivalent capacitance,
wherein the amplifier receives a trigger signal at the input of the amplifier, and the voltage level at the output of the amplifier and the equivalent capacitance have a relationship below:
$$\frac{Vout}{Vin 2} = - [ \frac{{C}_{in}}{( \frac{G + 1}{G} ) \times ( {C}_{1} + {C}_{2} + {C}_{3} ) + \frac{{C}_{F}}{G} + \frac{( \frac{{C}_{PF} \times {C}_{JUN}}{{C}_{PF} + {C}_{JUN}} )}{G}} ]$$
where Vin2 represents a voltage level of the trigger signal, wherein the trigger signal is input from the outside of the sensing device, Vout represents the voltage level at the output of the amplifier, G represents an open-loop gain of the amplifier, C_{F} represents the capacitance, C_{PF} represents the first capacitance, C_{JUN} represents the second capacitance, C₁ represents the first feedback capacitance, C₂ represents the second feedback capacitance, and C₃ represents the third feedback capacitance.
